(19) United States
(12) Patent Application Publication
(10) Pub. No.: US 2014/0003635 A1
(43) Pub. Date: Jan. 2, 2014

(54) AUDIO SIGNAL PROCESSING DEVICE CALIBRATION

(71) Applicant: QUALCOMM INCORPORATED, San Diego, CA (US)

(72) Inventors: Asif Iqbal Mohammad, San Diego, CA (US); Lae-Hoon Kim, San Diego, CA (US); Erik Visser, San Diego, CA (US)

(73) Assignee: QUALCOMM Incorporated, San Diego, CA (US)

(21) Appl. No.: 13/801,021

(22) Filed: Mar. 13, 2013

Related U.S. Application Data
(60) Provisional application No. 61/667,249, filed on Jul. 2, 2012.
(60) Provisional application No. 61/681,474, filed on Aug. 9, 2012.

(51) Int. Cl. G10K 11/16

(52) U.S. Cl. CPC G10K 11/16
USPC 381/306; 381/300; 381/66

(57) ABSTRACT

A method includes, while operating an audio processing device in a use mode, retrieving first direction of arrival (DOA) data corresponding to a first audio output device from a memory of the audio processing device and generating a first null beam directed toward the first audio output device based on the first DOA data. The method also includes retrieving second DOA data corresponding to a second audio output device from the memory of the audio processing device and generating a second null beam directed toward the second audio output device based on the second DOA data. The first DOA data and the second DOA data are stored in the memory during operation of the audio processing device in a calibration mode.

### CLAIM OF PRIORITY

This application claims priority from U.S. Provisional Patent Application No. 61/667,249 filed on Jul. 2, 2012 and entitled “AUDIO SIGNAL PROCESSING DEVICE CALIBRATION,” and claims priority from U.S. Provisional Patent Application No. 61/681,474 filed on Aug. 9, 2012 and entitled “AUDIO SIGNAL PROCESSING DEVICE CALIBRATION,” the contents of each of which are incorporated herein in their entirety.

### FIELD OF THE DISCLOSURE

The present disclosure relates to calibration of an audio signal processing device.

### BACKGROUND

Teleconferencing applications are becoming increasingly popular. Implementing teleconferencing applications on certain devices, such as smart televisions, presents certain challenges. For example, echo in teleconferencing calls can be a problem. An echo cancellation device may be used to model an acoustic room response, estimate an echo, and subtract the estimated echo from a desired signal to transmit an echo free (or echo reduced) signal. When an electronic device used for teleconferencing is coupled to multiple external speakers (e.g., such as a home theater systems), multiple correlated acoustic signals may be generated that can be difficult to effectively cancel.

### SUMMARY

In a particular embodiment, an electronic device, such as a television or other home theater component that is adapted for use for teleconferencing, includes a calibration module. The calibration module may be operable to determine a direction of arrival of sound from loudspeakers of a home theater system. The electronic device may use beamforming to null signals from particular loudspeakers (e.g., to improve echo cancellation performance). The calibration module may also be configured to estimate acoustic coupling delays. The estimated acoustic coupling delays may be used to update a delay tuning parameter of an audio processing device that includes an echo cancellation device.

In a particular embodiment, a method includes, while operating an audio processing device in a use mode, retrieving first direction of arrival (DOA) data corresponding to a first audio output device from a memory of the audio processing device and generating a first null beam directed toward the first audio output device based on the first DOA data. The method also includes retrieving second DOA data corresponding to a second audio output device from the memory of the audio processing device and generating a second null beam directed toward the second audio output device based on the second DOA data. The first DOA data and the second DOA data were stored in the memory during operation of the audio processing device in a calibration mode.

In another particular embodiment, an apparatus includes an audio processing device. The audio processing device includes a memory to store direction of arrival (DOA) data that is determined while the audio processing device is operating in a calibration mode. The audio processing device also includes a beamforming device. While the audio processing device is operating in a use mode, the beamforming device performs operations including retrieving first DOA data corresponding to a first audio output device from the memory, generating a first null beam directed toward the first audio output device based on the first DOA data, retrieving second DOA data corresponding to a second audio output device from the memory, and generating a second null beam directed toward the second audio output device based on the second DOA data.

In another particular embodiment, a non-transitory computer-readable medium stores instructions that that are executable by a processor to cause the processor to perform operations including, while operating an audio processing device in a use mode, retrieving first direction of arrival (DOA) data corresponding to a first audio output device from a memory and generating a first null beam directed toward the first audio output device based on the first DOA data. The operations also include retrieving second DOA data corresponding to a second audio output device from the memory of the audio processing device and generating a second null beam directed toward the second audio output device based on the second DOA data. The first DOA data and the second DOA data were stored in the memory during operation of the audio processing device in a calibration mode

In another particular embodiment, an apparatus includes means for storing direction of arrival (DOA) data determined while an audio processing device operated in a calibration mode. The apparatus also includes means for generating a null beam based on the DOA data stored at the means for storing DOA data. The means for generating a null beam is configured to, while the audio processing device is operating in a use mode, retrieve first DOA data corresponding to a first audio output device from the means for storing DOA data and generate a first null beam directed toward the first audio output device based on the first DOA data, and retrieve second DOA data corresponding to a second audio output device from the means for storing DOA data and generate a second null beam directed toward the second audio output device based on the second DOA data.

In another particular embodiment, a method of using an audio processing device during a conference call includes delaying, by a delay amount, application of a signal to an echo cancelation device of an audio processing device. The delay amount is determined based on an estimated electric delay between an audio output interface of the audio processing device and a second device of a home theater system. The estimated electric delay is obtained during operation of the audio processing device in a calibration mode.

In another particular embodiment, an apparatus includes means for reducing echo in a second signal based on a first signal. The apparatus also includes means for delaying, by a delay amount, application of the first signal to the means for reducing echo. The delay amount is determined based on an estimated electric delay between an audio output interface of an audio processing device and a second device of a home theater system. The estimated electric delay is obtained during operation of the audio processing device in a calibration mode.

In another particular embodiment, an apparatus includes an audio processing device. The audio processing device includes an audio input interface to receive a first signal. The audio processing device also includes an audio output interface to send the first signal to a second device of a home theater system. The audio processing device further includes an echo cancellation device coupled to the audio output interface and the audio input interface. The echo cancellation device is configured to reduce echo associated with an acoustic signal generated by an acoustic output device of the home theater system and received at an input device coupled to the audio processing device. The audio processing device also includes a delay component coupled between the audio output interface and the echo cancellation device. The delay component is configured to delay, by a delay amount, application of the first signal to the echo cancelation device. The delay amount is determined based on an estimated electric delay between the audio output interface of the audio processing device and the second device of the home theater system. The estimated electric delay is obtained during operation of the audio processing device in a calibration mode.

One particular advantage provided by at least one of the disclosed embodiments is improved performance of home theater equipment for teleconferencing.

Other aspects, advantages, and features of the present disclosure will become apparent after review of the entire application, including the following sections: Brief Description of the Drawings, Detailed Description, and the Claims.

### BRIEF DESCRIPTION OF THE DRAWINGS

FIG. 1 is a block diagram of a particular illustrative embodiment of a home theater system adapted for teleconferencing;

FIG. 2 is a block diagram of a particular illustrative embodiment of an audio processing device operating in a delay calibration mode;

FIG. 3 is a block diagram of a particular illustrative embodiment of an audio processing device operating in a delay use mode;

FIG. 4 is a block diagram of a particular illustrative embodiment of an audio processing device operating in a beamforming calibration mode;

FIG. 5 is a block diagram of a particular illustrative embodiment of an audio processing device operating in a delay use mode;

FIG. 6 is a block diagram of a particular illustrative embodiment of an audio processing device operating in a beamforming use mode;

FIG. 7 is a flowchart of a first particular embodiment of a method of operation of an audio processing device;

FIG. 8 is a flowchart of a second particular embodiment of a method of operation of an audio processing device;

FIG. 9 illustrates charts of simulated true room responses showing first and second delays and simulated down-sampled adaptive filter outputs associated with the simulated true room responses;

FIG. 10 illustrates charts of simulated true room response showing third and fourth delays and simulated down-sampled adaptive filter outputs associated with the simulated true room responses;

FIG. 11A shows a far-field model of plane wave propagation relative to a microphone pair;

FIG. 11B shows multiple microphone pairs in a linear array;

FIG. 12A shows plots of unwrapped phase delay vs. frequency for four different DOAs;

FIG. 12B shows plots of wrapped phase delay vs. frequency for the same DOAs;

FIG. 13A shows an example of measured phase delay values 215 and calculated values for two DOA candidates;

FIG. 13B shows a linear array of microphones arranged along a top margin of a television screen;

FIG. 14A shows an example of calculating DOA differences for a frame;

FIG. 14B shows an example of calculating a DOA estimate;

FIG. 14C shows an example of identifying a DOA estimate for each frequency;

FIG. 15A shows an example of using calculated likelihoods to identify a best microphone pair and best DOA candidate for a given frequency;

FIG. 15B shows an example of likelihood calculation;

FIG. 16A shows an example of a particular application;

FIG. 16B shows a mapping of pair-wise DOA estimates to a 360° range in the plane of the microphone array;

FIGS. 17A and 17B show an ambiguity in the DOA estimate;

FIG. 17C shows a relation between signs of observed DOAs and quadrants of an x-y plane;

FIGS. 18A-18D show an example in which the source is located above the plane of the microphones;

FIG. 18E shows an example of microphone pairs along non-orthogonal axes;

FIG. 18F shows an example of use of the array to obtain a DOA estimate with respect to the orthogonal x and y axes;

FIGS. 19A and 19B show examples of pair-wise normalized beamformer/null beamformers (BFNFs) for a two-pair microphone array (e.g., as shown in FIG. 20A);

FIG. 20A shows an example of a two-pair microphone array;

FIG. 20B shows an example of a pair-wise normalized minimum variance distortionless response (MVDR) BFNF;

FIG. 21A shows an example of a pair-wise BFNF for frequencies in which the matrix A^{H}A is not ill-conditioned;

FIG. 21B shows examples of steering vectors;

FIG. 21C shows a flowchart of an integrated method of source direction estimation as described herein;

FIG. 22 is a flowchart of a third particular embodiment of a method of operation of an audio processing device;

FIG. 23 is a flowchart of a fourth particular embodiment of a method of operation of an audio processing device; and

FIG. 24 is a flowchart of a fifth particular embodiment of a method of operation of an audio processing device;

FIG. 25 is a flowchart of a sixth particular embodiment of a method of operation of an audio processing device;

FIG. 26 is a flowchart of a seventh particular embodiment of a method of operation of an audio processing device;

FIG. 27 is a flowchart of a eighth particular embodiment of a method of operation of an audio processing device;

FIG. 28 is a flowchart of a ninth particular embodiment of a method of operation of an audio processing device;

FIG. 29 is a flowchart of a tenth particular embodiment of a method of operation of an audio processing device; and

FIG. 30 is a flowchart of an eleventh particular embodiment of a method of operation of an audio processing device.

### DETAILED DESCRIPTION

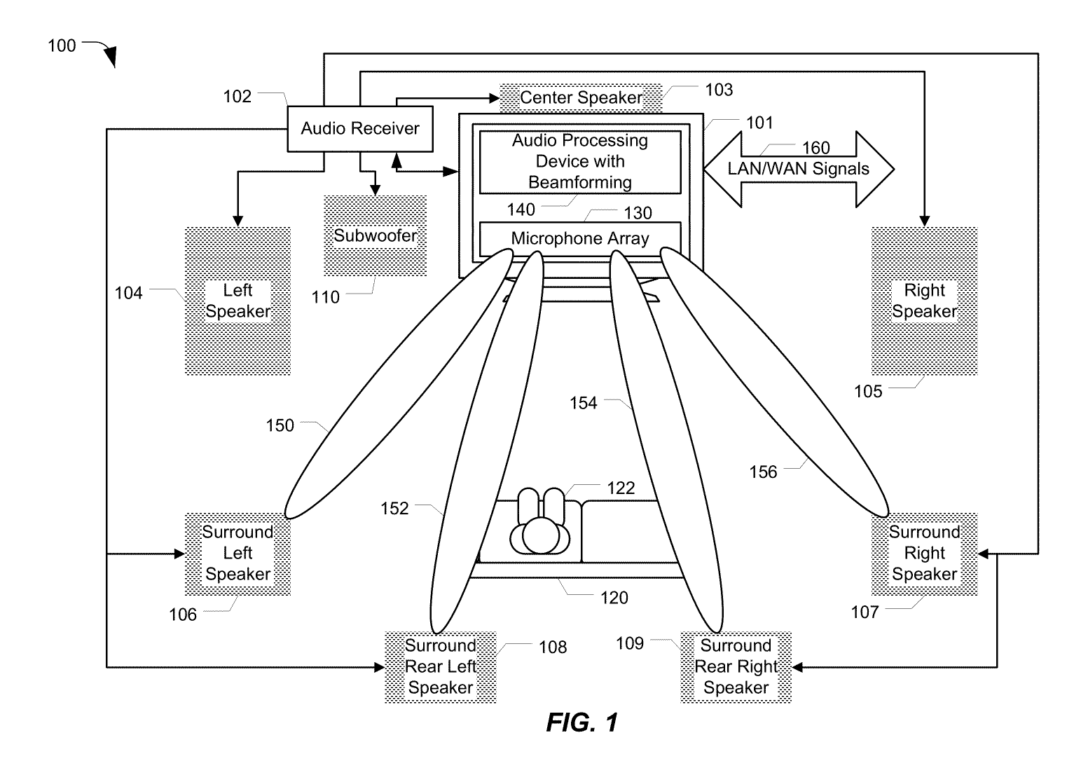

FIG. 1 is a block diagram of a particular illustrative embodiment of a home theater system 100. The home theater system 100 is adapted for receiving voice interaction from a user 122. For example, the home theater system 100 may be used for teleconferencing (e.g., audio or video teleconferencing), to receive voice commands (e.g., to control a component of the home theater system 100 or another device), or to output voice input received from the user 122 (e.g., for voice amplification or audio mixing).

The home theater system 100 may include an electronic device 101 (e.g., a television) coupled to an audio receiver 102. For example, the electronic device 101 may be a networking-enabled “smart” television that is capable of communicating local area network (LAN) and/or wide area network (WAN) signals 160. The electronic device 101 may include or be coupled to a microphone array 130 and an audio processing component 140. The audio processing component 140 may be operable to (e.g., configured to) implement an adjustable delay for use in echo cancellation (e.g., during audio and/or video conferencing scenarios), to implement beamforming to reduce echo due to output of particular loudspeakers of the home theater system 100, or both.

The audio receiver 102 may receive audio signals from an audio output of the electronic device 101, process the audio signals, and send signals to each of a plurality of external loudspeakers and/or a subwoofer for output. For example, the audio receiver 102 may receive a composite audio signal from the electronic device 101 via a multimedia interface, such as a high-definition multimedia interface (HDMI). The audio receiver 102 may process the composite audio signal to generate separate audio signals for each loudspeaker and or subwoofer. In the embodiment of FIG. 1, seven loudspeakers 103-109 and a subwoofer 110 are shown. It should be noted, however, that the embodiments of the present disclosure may include more or fewer loudspeakers and/or subwoofers.

When the home theater system 100 is set up, each component may be positioned relative to a seating area 120 to facilitate use of the home theater system 100 (e.g., to improve surround-sound performance). Of course, other arrangements of the components of the home theater system 100 are also possible and are within the scope of the present disclosure. When voice input is to be received from the user 122 (e.g., in an audio/video conferencing scenario) at a device in which a microphone and loudspeaker(s) are located close to each other or are incorporated into a single device, a delay between a reference signal (e.g., a far-end audio signal) and a signal received at the microphone (e.g., a near-end audio signal) is typically within an expected echo cancellation range. Thus, an echo cancellation device (e.g., an adaptive filter) receiving the near-end and far-end signals may be capable of performing acoustic echo cancellation. However, in home theater systems, the speaker-microphone distances and the presence of the audio receiver 102 may increase the delay between the near-end and far-end signals to an extent that a conventional adaptive filter can no longer perform acoustic echo cancellation effectively. For example, the adaptive filter may take longer to converge. Echo cancellation is further complicated in the home theater system 100 because the home theater system 100 includes multiple loudspeakers that typically output signals that are correlated.

The audio processing component 140 may be configured to operate in one or more calibration modes to prepare or configure the home theater system 100 of FIG. 1 to implement acoustic echo cancellation. For example, a calibration mode (or more than one calibration mode) may be initiated based on user input or may be initiated automatically upon detecting a configuration change (e.g., an addition or removal of a component of the home theater system). During operation in a calibration mode, the electronic device 101 may estimate delay values 215 (e.g., an estimated electric delay between an audio output interface of the audio processing device and a second device of a home theater system) that are subsequently used for echo cancellation, as described further below.

Additionally or in the alternative, during operation in the calibration mode, the electronic device 101 may determine direction of arrival (DOA) information that is used subsequently for echo cancellation. To illustrate, the electronic device 101 may output an audio pattern (e.g., a calibration signal, such as white noise) for a particular period of time (e.g., five seconds) to the audio receiver 102. The audio receiver 102 may process the audio pattern and provide signals to the loudspeakers 103-109 and the subwoofer 110, one at a time. For example, a first loudspeaker 103 may output the audio pattern while the rest of the loudspeakers 104-109 and the subwoofer 110 are silent. Subsequently, another of the loudspeakers, such as a second loudspeaker 104) may output the audio pattern while the rest of the loudspeakers 103 and 105-109 and the subwoofer 110 are silent. This process may continue until each loudspeaker 103-109 and optionally the subwoofer 110 have output the audio pattern. While a particular loudspeaker or the subwoofer 110 outputs the audio pattern, the microphone array 130 may receive acoustic signals output from the particular loudspeaker or the subwoofer 110. The audio processing component 140 may determine DOA of the acoustic signals, which corresponds to a direction from the microphone array 130 to the particular loudspeaker. After determining a DOA for each of the loudspeakers 103-109 and the subwoofer 110 (or a subset thereof), an estimate delay value for each of the loudspeakers 103-109 and the subwoofer 110 (or a subset thereof), or both, calibration is complete.

During operation in a non-calibration mode (e.g., a use mode) after calibration is complete, the audio processing component 140 may delay far-end signals provided to an echo cancellation device of the audio processing component 140 based on the delay determined during the calibration mode. Alternatively or in addition, the audio processing component 140 may perform beamforming to null out signals received from particular directions of arrival (DOAs). In a particular embodiment, nulls are generated corresponding to forward facing loudspeakers, such as the loudspeakers 106-109. For example, as illustrated in FIG. 1, the audio processing component 140 has generated nulls 150, 152, 154, 156 corresponding to loudspeakers 106-109. Thus, although acoustic signals from loudspeakers 106-109 are received at the microphone array 130, audio data corresponding to these acoustic signals is suppressed using beamforming based on the DOA associated with each of the loudspeakers 106-109. Suppressing audio data from particular loudspeakers decreases processing that is performed by the audio processing component to reduce echo associated with the home theater system 100.

When a subsequent configuration change is detected (e.g., a different audio receiver or a different speaker is introduced into the home theater system 100), the calibration mode may be initiated again and one or more new or updated delay values 215, one or more new or updated DOAs, or a combination thereof, may be determined by the audio processing component 140.

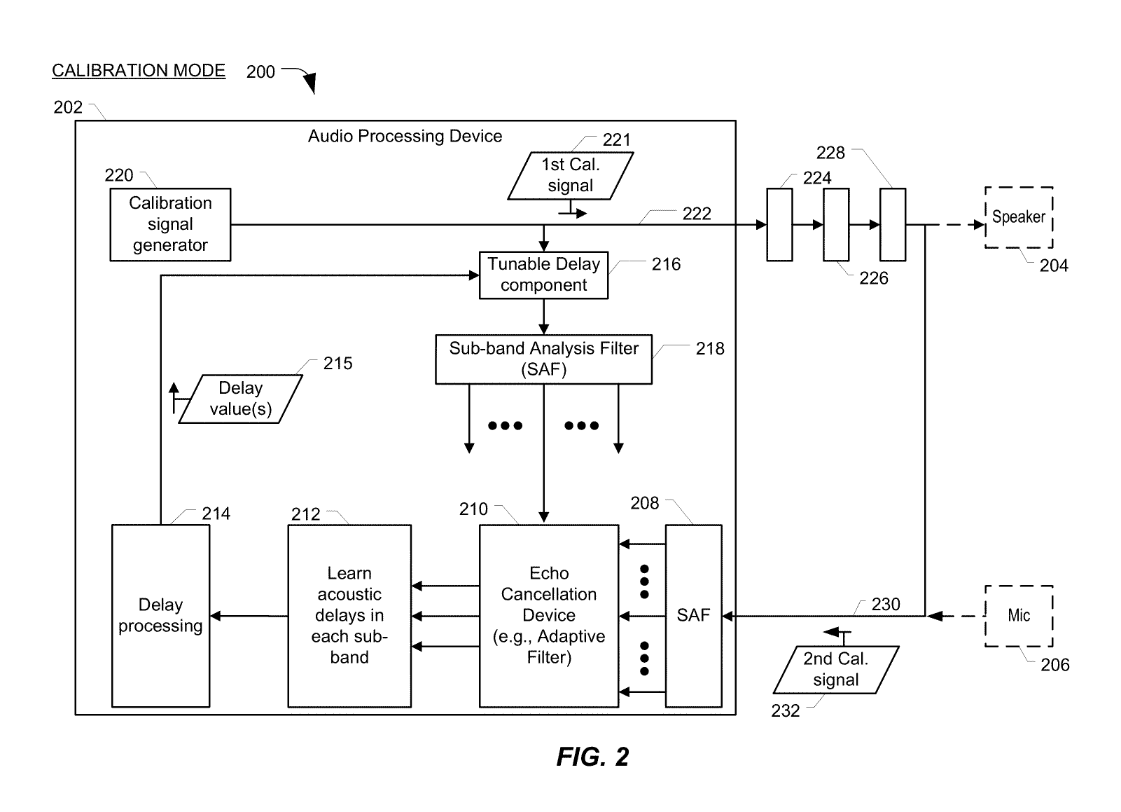

FIG. 2 is a block diagram of a particular illustrative embodiment of a system 200 including an audio processing device 202 operating in a calibration mode. The audio processing device 202 may include or be included within the audio processing component 140 of FIG. 1. The audio processing device 202 includes an audio output interface 222 that is configured to be coupled to one or more other devices of a home theater system, such as a set top box device 224, a television 226, an audio receiver 228, or another device (not shown) and to acoustic output devices (such as a speaker 204). For example, the audio output interface 222 may include an audio bus coupled to or terminated by one or more speaker connectors, a multimedia connector (such as a high definition multimedia interface (HDMI) connector), or a combination thereof. During operation of the system 200 in a use mode, more than one speaker may be present; however, the description that follows refers to the speaker 204 in the singular to simplify the description. Further, during operation of the system 200 in the calibration mode, as illustrated in FIG. 2, the speaker 204 may not be used and may be omitted. The audio processing device 202 may also include an audio input interface 230 that is configured to be coupled to one or more acoustic input devices (such as a microphone 206). For example, the audio input interface 230 may include an audio bus coupled to or terminated by one or more microphone connectors, a multimedia connector (such as an HDMI connector), or a combination thereof. During operation of the system 200 in a use mode, more than one microphone may be present; however, the description that follows refers to the microphone 206 in the singular to simplify the description. Further, during operation of the system 200 in the calibration mode, as illustrated in FIG. 2, the microphone 206 may not be used and may be omitted.

During a teleconference call (e.g., in the use mode of operation), the microphone 206 may detect speech output by a user. However, sound output by the speaker 204 may also be received at the microphone 206 causing echo. The audio processing device 202 may include an echo cancellation device 210 (e.g., an adaptive filter, an echo suppressor, or another device or component operable to reduce echo) to process a received audio signal from the audio input interface 230 to reduce echo. Depending on where a user positions the speaker 204 and the microphone 206, the delay between the speaker 204 and the microphone 206 may be too large for the echo cancellation device 210 to effectively reduce the echo (as a result of electrical signal propagation delays, acoustic signal propagation delays, or both). The delay between when the audio processing device 202 outputs a signal via the audio output interface 222 and when the audio processing device 202 receives input including echo at the audio input interface 230 includes acoustic delay (e.g., delay due to propagation of sound waves) and electric delay (e.g., delay due to processing and transmission of the output signal after the output signal leaves the audio processing device 202). The acoustic delay may be related to relative positions and orientation of the speaker 204 and the microphone 206. For example, if the speaker 204 and the microphone 206 are relatively far from each other, the acoustic delay will be long than if the speaker 204 and the microphone 206 are relative close to each other. The electric delay is related to lengths of transmission lines that are between the audio processing device 202, the other components of the home theater system (e.g., the set top box device 224, the television 226, the audio receiver 228), and the speaker 204. The electric delay may also be related to processing delays caused by the other components of the home theater system (e.g., the set top box device 224, the television 226, the audio receiver 228). Thus, for example, acoustic delay may be changed when the speaker 204 is repositioned; however, the electric delay may not be changed by the repositioning as long as the lengths of the transmission lines are not changes (e.g., if the speaker 204 is repositioned by rotating the speaker 204 or by moving the speaker closer to the audio receiver 228).

In a particular embodiment, the audio processing device 202 includes a tunable delay component 216. A delay processing component 214 may determine one or more delay values 215 that are provided to the tunable delay component 216 to adjust (e.g., tune) a delay in providing an output signal of the audio processing device 202 (e.g., a signal from the audio output interface 222) to the echo cancellation device 210 to adjust an overall echo cancellation processing capability of the audio processing device to accommodate the delay. When more than one speaker, more than one microphone, or both, are present, delays between various speaker and microphone pairs may be different. In this case, the tunable delay component 216 may be adjusted to a delay value or delay values that enables the echo cancellation device 210 to reduce echo associated with each speaker and microphone pair. In a particular embodiment, the delay values 215 are indicative of estimated electric delay between the audio output interface 222 of the audio processing device 202 and a second device of a home theater system, such as the set top box 224, the television 226, or the audio receiver 228.

In a particular embodiment, the echo cancellation device 210 includes a plurality of echo cancellation circuits. Each of the plurality of echo cancellation circuits may be configured to reduce echo in a sub-band of a received audio signal. Note that while a received audio signal may be relatively narrowband (e.g., about 8 KHz within a human auditory range), the sub-bands are still narrower bands. For example, the audio processing device 202 may include a first sub-band analysis filter 208 coupled to the audio input interface 230. The first sub-band analysis filter 208 may divide the received audio signal into a plurality of sub-bands (e.g., frequency ranges) and provide each sub-band of the received audio signal to a corresponding echo cancellation circuit of the echo cancellation device 210. The audio processing device 202 may also include a second sub-band analysis filter 218 coupled between the audio output interface 222 and the echo cancellation device 210. The second sub-band analysis filter 218 may divide an output signal of the audio processing device 202 (such as first calibration signal 221 when the audio processing device is in the calibration mode) into the plurality of sub-bands (e.g., frequency ranges) and provide each sub-band of the output signal to a corresponding echo cancellation circuit of the echo cancellation device 210.

During operation of the system 200 in the calibration mode, a calibration signal generator 220 of the audio processing device 202 may output a first calibration signal 221. The first calibration signal 221 may be sent for a time period (e.g., 5 seconds) to one or more other devices of the system 200 (such as the set top box 224, the television 226, or the audio receiver 228) via the audio output interface 222. The first calibration signal 221 may also be provided to the second sub-band analysis filter 218 to be divided into output sub-bands. In the calibration mode, the tunable delay component 216 is typically not used. That is, the first calibration signal 221 is provided to the second sub-band analysis filter 218 and the echo cancellation device 210 without delay imposed by the tunable delay component 216.

In the calibration mode, an audio output of a component of the system 200 (such as the set top box 224, the television 226, or the audio receiver 228) may be coupled to the audio input interface 230. For example, a speaker wire that is coupled to the speaker 204 during the use mode of operation may be temporarily rerouted to couple to the audio input interface 230 during the calibration mode of operation. Alternately, a dedicated audio output of the component of the system 200 may be coupled to the audio processing device 202 for use during the calibration mode of operation.

A second calibration signal 232 may be received at the audio processing device 202 via the audio input interface 230. The second calibration signal 232 may correspond to the first calibration signal 221 as modified by and/or as delayed by one or more component of the system 200 (such as the set top box 224, the television 226, the audio receiver 228, and transmission lines therebetween). The second calibration signal 232 may be divided into input sub-bands by the first sub-band analysis filter 208. Echo cancellation circuits of the echo cancellation device 210 may process the input sub-bands (based on the second calibration signal 232) and the output sub-bands (based on the first calibration signal 221) to estimate delay associated with each sub-band. Note that using sub-bands of the signals enables the echo cancellation device 210 to converge more quickly than if the full bandwidth signals were used.

In a particular embodiment, a delay estimation module 212 learns (e.g., determines) delays for each sub-band. A delay processing component 214 determines a delay value or delay values 215 that are provided to the tunable delay component 216.

As illustrated in FIG. 2, the delay values 215 correspond to estimated electrical delay between the audio processing device 202 and one or more other component of the system 200 (such as the set top box 224, the television 226, or the audio receiver 228). In other embodiments, overall delay for the system 200 may be estimated. The overall delay may include the electric delay as well as acoustic delay due to propagation of sound output by the speaker 204 and detected by the microphone 206. The delay values 215 may correspond to an average of the sub-band delays, a maximum of the sub-band delays, a minimum of the sub-band delays, or another function of the sub-band delays.

In other embodiments, a plurality of tunable delay components 216 may be provided between the second sub-band analysis filter 218 and the echo cancellation device (rather than or in addition to the tunable delay component 216 illustrate in FIG. 2 between the second sub-band analysis filter 218 and the audio output interface 222). In such embodiments, the delay values 215 may include a delay associated with each sub-band. After the calibration mode is complete, in a use mode, subsequent signals from the audio output interface 222 to the echo cancellation device 210 may be delayed by the tunable delay component 216 (or tunable delay components) by an amount that corresponds to the delay values 215.

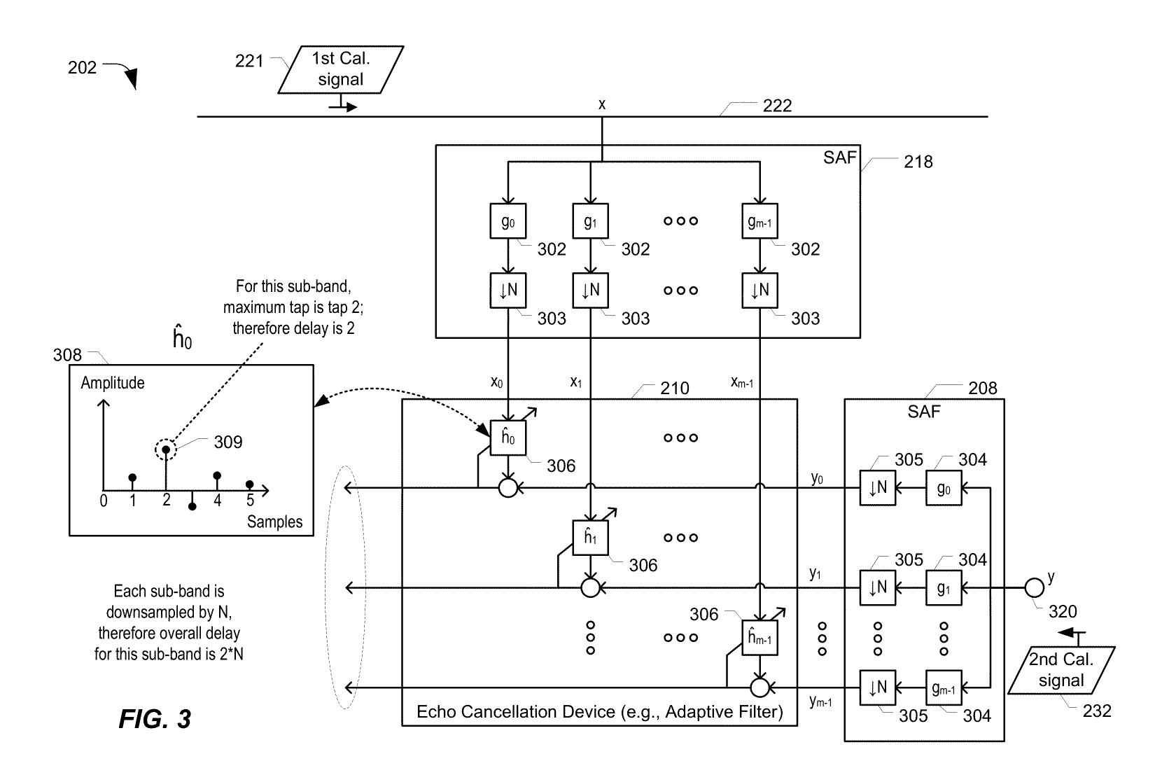

FIG. 3 is a block diagram of a particular illustrative embodiment of the audio processing device 202 operating in a calibration mode showing additional details regarding determining the delay values 215. The first calibration signal 221, x, is fed into the second sub-band analysis filter 218 producing M sub-band signals (e.g., x₀ though xₘ₋₁). The sub-band analysis filters 218 and 208 may be implemented in a variety of ways. FIG. 3 illustrates one particular, non-limiting example of a manner of implementing the sub-band analysis filters 208, 218. In a particular embodiment, the first sub-band analysis filter 218 works as follows. The first calibration signal 221 is filtered through a parallel set of M band pass filters 302, g₀ through gₘ₋₁, to produce M sub-band signals. Each sub-band signal has a bandwidth that is 1/M times the original band-width of the first calibration signal 221. The sub-band signals may be down-sampled, because the Nyquist-Shannon theorem indicates that perfect reconstruction of a signal is possible when the sampling frequency is greater than twice the maximum frequency of the signal being sampled. Thus, the signal in each sub-band can be down-sampled, at 303, by a factor of N (N<=M). In other words, each sample in the sub-band domain occupies the time duration of N samples in the original signal.

When the second calibration signal 232 is received, it is passed through a first sub-band analysis filter 208 to produce M sub-band signals. The second calibration signal 232 is filtered through a parallel set of M band pass filters 304 to produce M sub-band signals. The signal in each sub-band can be down-sampled, at 305, by a factor of N (N<=M).

In a particular embodiment, the echo cancellation device 210 includes an adaptive filter 306 that runs in each of the sub-bands to cancel the echo in the respective sub-band. For example, the adaptive filter 306 in each sub-band may suppress the portion of the second calibration signal 232 that is correlated with the first calibration signal 221. The adaptive filter 306 in each sub-band determines an adaptive filter coefficient related to the echo. A largest amplitude adaptive filter coefficient tap location 309 represents the delay (in samples) between the first calibration signal 221 and the second calibration signal 232. Each sample in a sub-band domain 308 occupies the time duration of N samples in the first calibration signal 221. Thus, the overall delay, in terms of sample value of the first calibration signal 221, is tap location of the largest amplitude adaptive filter coefficient times the down-sampling factor. For example, in FIG. 3, the largest tap 309 location is at tap 2 and the down-sampling factor 307 is N, thus the overall delay is 2N.

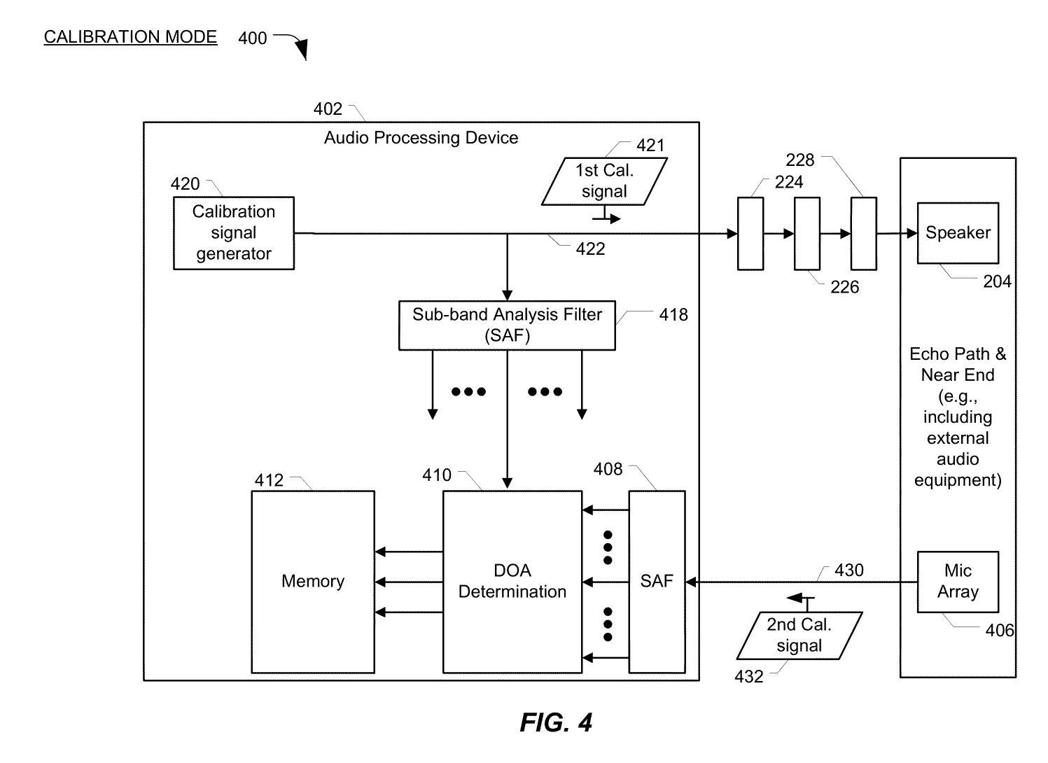

FIG. 4 is a block diagram of a particular illustrative embodiment of an audio processing device 402 operating in a calibration mode. The audio processing device 402 may include, be included within, or correspond to the audio processing component 140 of FIG. 1. Additionally, or in the alternative, the audio processing device 402 may include, be included within, or correspond to the audio processing device 202 of FIG. 2. For example, although they are not illustrated in FIG. 4, the audio processing device 402 may include the tunable delay component 216, the echo cancellation device 210, the delay estimation module 212, the delay processing module 214, or a combination thereof. Additionally, a calibration signal generator 420 of the audio processing device 402 may include, be included within, or correspond to the calibration signal generator 220 of FIG. 2, and sub-band analysis filters 408, 418 of the audio processing device 402 may include, be included within, or correspond to the sub-band analysis filters 208, 218, respectively, of FIG. 2

The audio processing device 402 includes an audio output interface 422 that is configured to be coupled, via one or more other devices of a home theater system (such as the set top box device 224, the television 226, and the audio receiver 228) to one or more acoustic output devices (such as a speaker 404). For example, the audio output interface 422 may include an audio bus coupled to or terminated by one or more speaker connectors, a multimedia connector (such as a high definition multimedia interface (HDMI) connector), or a combination thereof. Although more than one speaker may be present, the description that follows describes determining a direction of arrival (DOA) for the speaker 404 to simplify the description. Directions of arrival (DOAs) for other speakers may be determined before or after the DOA of the speaker 404 is determined. While the following description describes determining the DOA for the speaker 404 in detail, in a particular embodiment, in the calibration mode, the audio processing device 402 may also determine the delay values 215 that are subsequently used for echo cancellation. For example, the delay values 215 may be determined before the DOA for the speaker 404 is determined or after the DOA for the speaker 404 is determined. The audio processing device 402 may also include an audio input interface 430 that is configured to be coupled to one or more acoustic input devices (such as a microphone array 406). For example, the audio input interface 430 may include an audio bus coupled to or terminated by one or more microphone connectors, a multimedia connector (such as an HDMI connector), or a combination thereof.

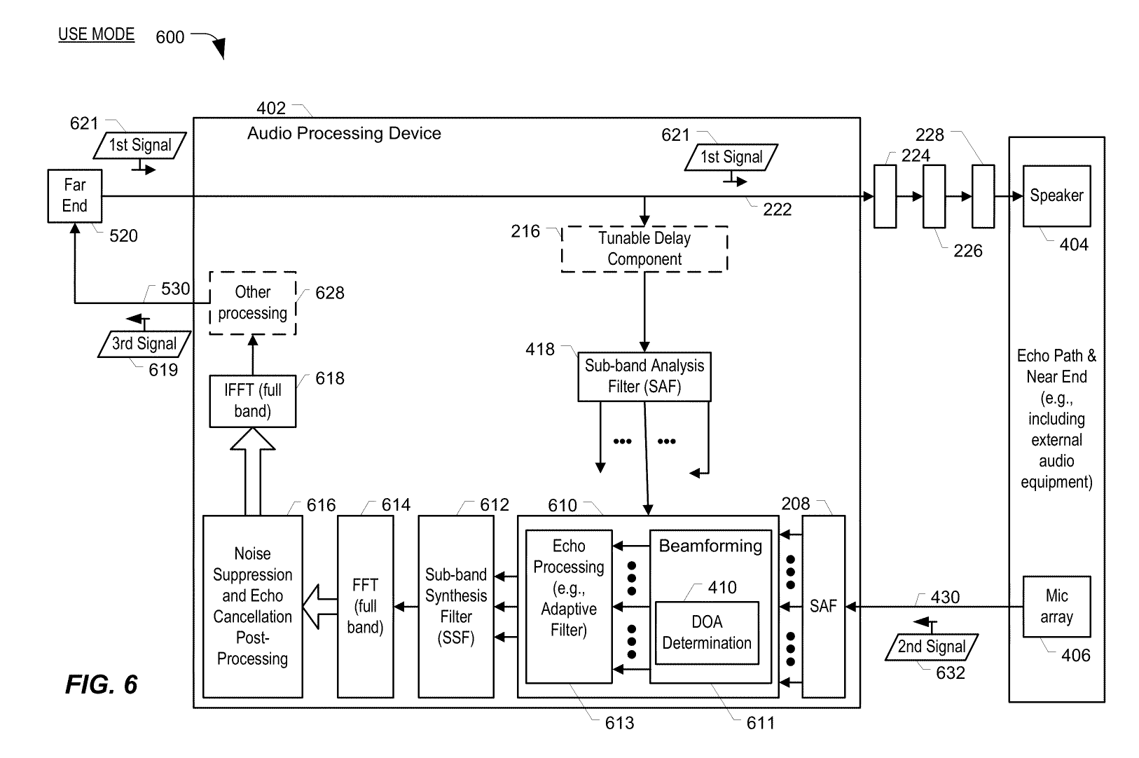

In a use mode, the microphone array 406 may be operable to detect speech from a user (such as the user 122 of FIG. 1). However, sound output by the speaker 404 (and one or more other speakers that are not shown in FIG. 4) may also be received at the microphone array 406 causing echo. Further, the sound output by the speakers may be correlated, making the echo particularly difficult to suppress. To reduce correlated audio data from the various speakers, the audio processing device 402 may include a beamformer (such as a beamforming component 611 of FIG. 6). The beamformer may use DOA data determined by a DOA determination device 410 to suppress audio data from particular speakers, such as the speaker 404.

In a particular embodiment, the DOA determination device 410 includes a plurality of DOA determination circuits. Each of the plurality of DOA determination circuits may be configured to determine DOA associated with a particular sub-band. Accordingly, the DOA determination device 410 or the DOA determination circuits, individually or together, may form means for determining a direction of arrival of an acoustic signal received at an audio input array (such as the microphone array 406). Further, the audio input interface 430 may include signal communication circuitry, connectors, amplifiers, other circuits, or a combination there that provide means for receiving audio data at the DOA determination device 410 from the microphone array 406.

While an audio signal received at the audio input interface 430 (such as a second calibration signal 432 when the audio processing device is in the calibration mode) may be relatively narrowband (e.g., about 8 KHz within a human auditory range), the sub-bands are still narrower bands. For example, the audio processing device 402 may include a first sub-band analysis filter 408 coupled to the audio input interface 430. The first sub-band analysis filter 408 may divide the received audio signal into a plurality of sub-bands (e.g., frequency ranges) and provide each sub-band of the received audio signal to a corresponding DOA determination circuit of the DOA determination device 410. The audio processing device 402 may also include a second sub-band analysis filter 418 coupled between the audio output interface 422 and the DOA determination device 410. The second sub-band analysis filter 418 may divide an output signal of the audio processing device 402 (such as a first calibration signal 421 when the audio processing device is in the calibration mode) into the plurality of sub-bands (e.g., frequency ranges) and provide each sub-band of the output signal to a corresponding DOA determination circuit of the DOA determination device 410.

To illustrate, in the calibration mode, the calibration signal generator 420 may output a calibration signal, such as the first calibration signal 421 for a time period (e.g., 5 seconds), to the speaker 404 via the audio output interface 422. The first calibration signal 421 may also be provided to the second sub-band analysis filter 418 to be divided into output sub-bands. In response to the first calibration signal 421, the speaker 404 may generate an acoustic signal (e.g., acoustic white noise), which may be detected at the microphone array 406. The acoustic signal detected at the microphone array 406 may be modified by a transfer function (associated, for example, with echo paths and near end audio paths) that is related to relative positions of the speaker 404 and the microphone array 406. The second calibration signal 432, corresponding to sound detected at the microphone array 406 while the speaker 404 is outputting the acoustic signal, may be provided by the microphone array 406 to the audio input interface 430. The second calibration signal 432 may be divided into input sub-bands by the first sub-band analysis filter 408. DOA determination circuits of the DOA determination device 410 may process the input sub-bands (based on the second calibration signal 432) and the output sub-bands (based on the first calibration signal 421) to determine a DOA associated with each sub-band. DOA data corresponding to the DOA for each sub-band may be stored at a memory 412. Alternately, or in addition, DOA data that is a function of the DOA for each sub-band (e.g., an average or another function of the sub-band DOAs) may be stored at a memory 412. If the audio processing device 402 is coupled to one or more additional speakers, calibration of the other speakers continues as DOAs for the one or more additional speakers are determined during the calibration mode. Otherwise, the calibration mode may be terminated and the audio processing device 402 may be ready to be operated in a use mode.

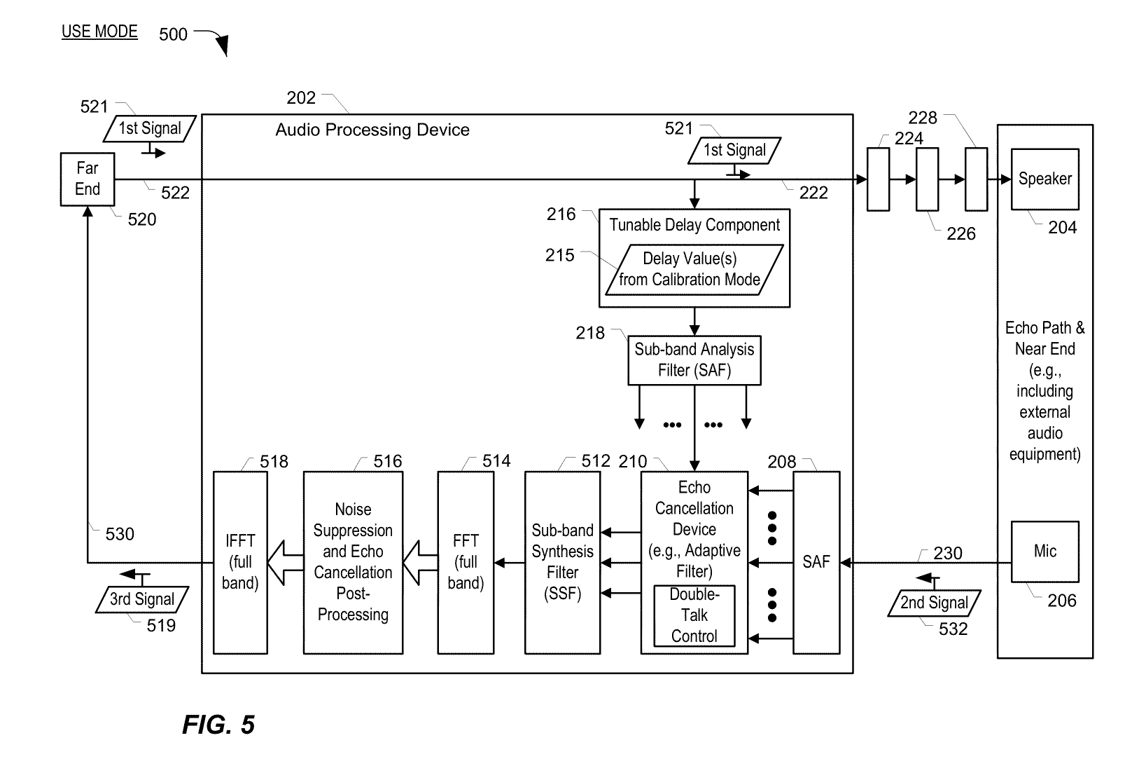

FIG. 5 is a block diagram of a particular illustrative embodiment of a system 500 including the audio processing device 202 of FIG. 2 operating in a use mode. For example, the audio processing device 202 may operate in the use mode during a teleconference after calibration using the calibration mode.

In the use mode, a first signal 521 may be received from a far end source 520. For example, the first signal 521 may include audio input received from another party to a teleconference call. The first signal 521 may be provided to the speaker 204 via the audio output interface 222 and one or more other devices of a home theater system (such as the set top box device 224, the television 226, and the audio receiver 228). The speaker 204 may generate an output acoustic signal responsive to the first signal 521. A received acoustic signal at the microphone 206 may include the output acoustic signal as modified by a transfer function as well as other audio (such as speech from a user at the near end). A second signal 532 corresponding to the received acoustic signal may be output by the microphone 206 to the audio input interface 230. Thus, the second signal 532 may include echo from the first signal 521.

In a particular embodiment, the first signal 521 is provided to the tunable delay component 216. The tunable delay component 216 may delay providing the first signal 521 for subsequent processing for a delay amount corresponding to the delay values 215 determined in the calibration mode. In this embodiment, after the delay, the tunable delay component 216 provides the first signal 521 to echo cancellation components to reduce the echo. For example, the first signal 521 may be provided to the second sub-band analysis filter 218 to be divided into output sub-bands, which are provided to the echo cancellation device 210. In this example, the second signal 532 may be provided to the first sub-band analysis filter 208 to be divided into input sub-bands, which are also provided to the echo cancellation device 210. The input sub-bands and output sub-bands are processed to reduce echo and to form echo corrected sub-bands, which may be provided to a sub-band synthesis filter 512 to be joined to form an echo cancelled received signal. In another example, a full bandwidth of the first signal 521 (rather than a set of sub-bands of the first signal 521) may be provided to the echo cancellation device 210. That is, the second sub-band analysis filter 218 may be omitted or bypassed. In this example, a full bandwidth of the second signal 532 may also be provided to the echo cancellation device 210. That is, the first sub-band analysis filter 208 may be omitted or bypassed. Thus, in this example, the echo may be reduced over the full bandwidth (in a frequency domain or an analog domain) rather than by processing a set of sub-bands.

In another embodiment, a plurality of tunable delay components (each with a corresponding delay value) are placed between the second sub-band analysis filter 218 and the echo cancellation device 210. In this embodiment, the first signal 521 is provided to the second sub-band analysis filter 218 to be divided into output sub-bands, which are then delayed by particular amounts by the corresponding tunable delay components before being provided to the echo cancellation device 210.

When echo cancellation is performed on individual sub-bands (rather than on the full bandwidth of the received signal from the audio input interface 230), the audio processing device 202 may include the sub-band synthesis filter 512 to combine the sub-bands to form a full bandwidth echo cancelled received signal. In a particular embodiment, additional echo cancellation and noise suppression may be performed by providing the echo cancelled received signal to a full-band fast Fourier transform (FFT) component 514, a frequency space noise suppression and echo cancellation post-processing component 516 and an inverse FFT component 518 before sending the a third signal 519 (e.g., an echo canceled signal) via an output 530 to the far end source 520. Alternately, or in addition, additional analog domain audio processing may be performed.

FIG. 6 is a block diagram of a particular illustrative embodiment of a system 600 including the audio processing device 402 of FIG. 4 operating in a use mode. For example, the audio processing device 402 may operate in the use mode, after completion of calibration during operation in the calibration mode, to conduct a teleconference, to received voice commands from a user, or to output voice input from the user (e.g., for karaoke or other voice amplification or mixing).

In the use mode, a first signal 621 may be received from the far end source 520. For example, the first signal 621 may include audio input received from another party to a teleconference call. Alternately, the first signal 621 may be received from a local audio source (e.g., audio output of a television or of another media device). The first signal 621 may be provided to the speaker 404 via the audio output interface 422 and one or more other devices of a home theater system (such as the set top box device 224, the television 226, and the audio receiver 228). The first signal 621 or another signal may also be provided to one or more additional speakers (not shown in FIG. 6). The speaker 404 may generate and output an acoustic signal responsive to the first signal 621. A received acoustic signal at the microphone array 406 may include the output acoustic signal as modified by a transfer function as well as other audio (such as speech from the user and acoustic signals from the one or more other speakers). A second signal 632 corresponding to the received acoustic signal may be output by the microphone array 406 to the audio input interface 430. Thus, the second signal 632 may include echo associated with the first signal 621, as well as other audio data.

In a particular embodiment, the first signal 621 is provided to a tunable delay component 216. The tunable delay component 216 may delay providing the first signal 621 for subsequent processing for a delay amount that corresponds to a delay values (e.g., the delay values 215 of FIG. 2) determined during operation of the audio processing device 402 the a calibration mode. The first signal 621 is subsequently provided to echo cancellation components to reduce the echo. For example, the first signal 621 may be provided to the second sub-band analysis filter 418 to be divided into output sub-bands, which are provided to an echo cancellation device 610. In this example, the second signal 632 may be provided to the first sub-band analysis filter 408 to be divided into input sub-bands, which are also provided to the echo cancellation device 610.

The echo cancellation device 610 may include beamforming components 611 and echo processing components 613. In the embodiment illustrated in FIG. 6, the second signal 632 is received from the audio input interface 430 at the beamforming components 611 before being provided to the echo processing components 613; however, in other embodiments, the beamforming components 611 are downstream of the echo processing components 613 (i.e., the second signal 632 is received from the audio input interface 430 at the echo processing components 613 before being provided to the beamforming components 611).

The beamforming components 611 are operable to use the direction of arrival (DOA) data from the memory 412 of FIG. 4 to suppress audio data associated with acoustic signals received at the microphone array 406 from particular directions. For example, audio data associated with the acoustic signals received from speakers that face the microphone array 406, such as the loudspeakers 106-109 of FIG. 1, may be suppressed by using the DOA data to generated nulls in the audio data received from the audio input interface 430. The echo processing components 613 may include adaptive filters or other processing components to reduce echo in the audio data based on a reference signal received from the audio output interface 422.

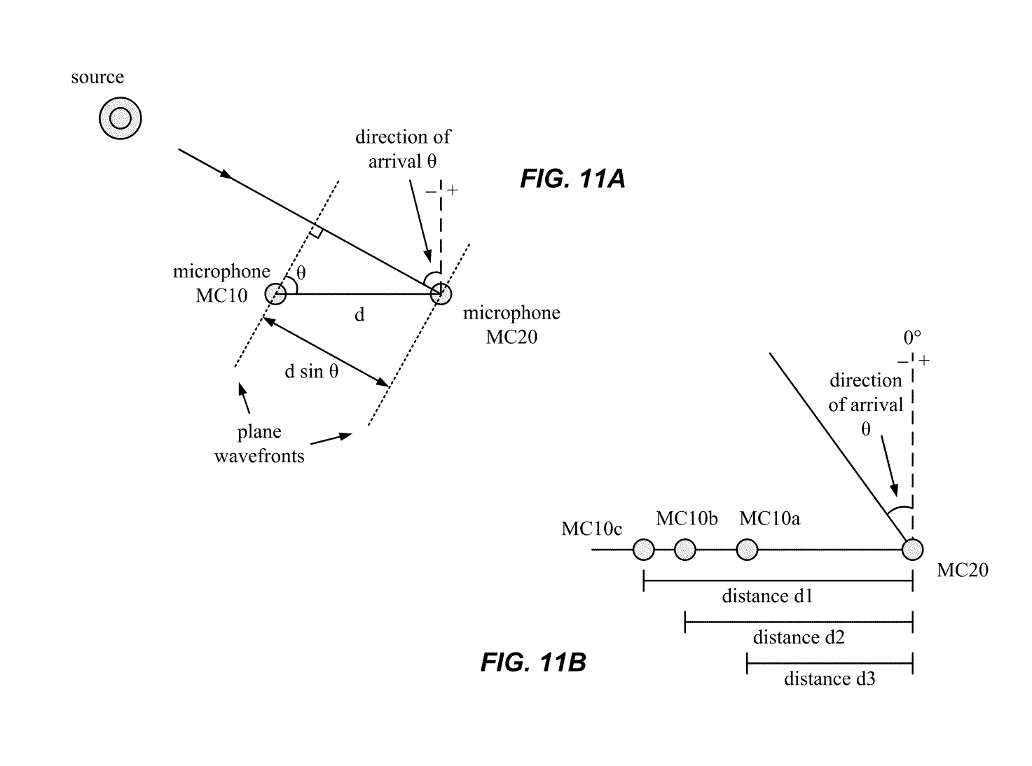

In a particular embodiment, the beamforming components 611, an echo cancellation post-processing component 616, another component of the audio processing device 402, or a combination thereof, may be operable to track a user that is providing voice input at the microphone array 406. For example, the beamforming components 611 may include the DOA determination device 410. The DOA determination device 410 may determine a direction of arrival of sounds produced by the user that are received at the microphone array 406. Based on the DOA of the user, the beamforming components 611 may track the user by modifying the audio data of the second signal 632 to focus on audio from the user, as described further with reference to FIGS. 11A-21C. In a particular embodiment, the beamforming components 611 may determine whether the DOA of the user coincides with a DOA of a speaker, such as the speaker 404, before suppressing audio data associated with the DOA of the speaker. When the DOA of the user coincides with the DOA of a particular speaker, the beamforming components 611 may use the DOA data to determine beamforming parameters that do not suppress a portion of the audio data that is associated with the particular speaker and the user (e.g., audio received from the coincident DOAs of the speaker and the user). The beamforming components 611 may also provide data to the echo processing components 613 to indicate to the echo processing components 613 whether particular audio data has been suppressed via beamforming.

After echo cancellation is performed on individual sub-bands, the echo cancelled sub-bands may be provided by the echo cancellation device 610 to a sub-band synthesis filter 612 to combine the sub-bands to form a full bandwidth echo cancelled received signal. In a particular embodiment, additional echo cancellation and noise suppression are performed by providing the echo cancelled received signal to a full-band fast Fourier transform (FFT) component 614, a frequency space noise suppression and echo cancellation post-processing component 616, and an inverse FFT component 618 before sending a third signal 619 (e.g., an echo cancelled signal) to the far end source 520 or to other audio processing components (such as mixing or voice recognition processing components). Alternately, or in addition, additional analog domain audio processing 628 may be performed. For example, the noise suppression and echo cancellation post-processing component 616 may be positioned between the echo processing components 613 and the sub-band synthesis filter 612. In this example, no FFT component 614 or inverse FFT component 618 may be used.

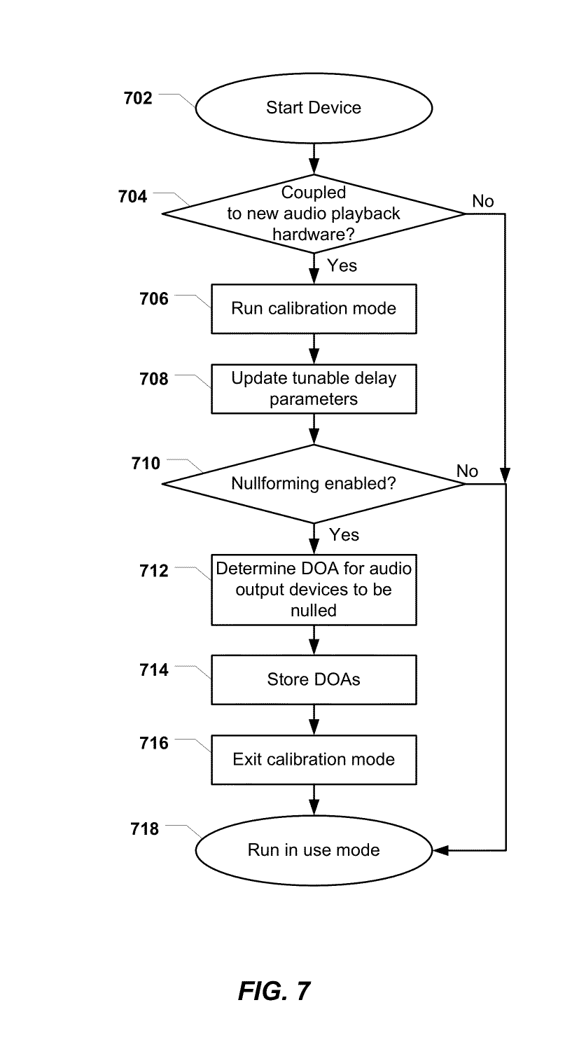

FIG. 7 is a flowchart of a first particular embodiment of a method of operation of an audio processing device. The method of FIG. 7 may be performed by the audio processing device 140 of FIG. 1, by the audio processing device 202 of FIG. 2, 3 or 5, by the audio processing device 402 of FIG. 4 or 6, or a combination thereof.

The method includes, at 702, starting the audio processing device. The method may also include, at 704, determining whether new audio playback hardware (such as one or more of the set top box device 224, the television 226, and the audio receiver 228, or the speaker 204 of FIG. 2) has been coupled to the audio processing device. For example, when new audio playback hardware is coupled to the audio processing device, the new audio playback hardware may provide an electrical signal that indicates presence of the new audio playback hardware. In another example, at start-up or at other times, the audio processing device may poll audio playback hardware that is coupled to the audio processing device to determine whether new audio playback hardware is present. In another example, a user may provide input that indicates presence of the new audio playback hardware. When no new audio playback hardware is present, the method ends, and the audio processing device is ready to run in a use mode, at 718.

When new audio playback hardware is detected, the method may include, at 706, running in a first calibration mode. The first calibration mode may be used to determine delay values, such as the delay values 215 of FIG. 2. The delay values may be used, at 708, to update tunable delay parameters. In a particular embodiment, the tunable delay parameters are used to delay providing a reference signal (such as the first calibration signal 221) to an echo cancellation device (such as the echo cancellation device 210) to increase an effective echo cancellation time range of echo processing components.

The method may also include determining whether nullforming (i.e., beamforming to suppress audio data associated with one or more particular audio output devices) is enabled, at 710. When nullforming is not enabled, the method ends, and the audio processing device is ready to run in a use mode, at 718. When nullforming is enabled, the method includes, at 712, determining a direction of arrival (DOA) for each audio output device that is to be nulled. At 714, the DOAs may be stored (e.g., at the memory 412 of FIG. 4) after they are determined. After a DOA is determined for each audio output device that is to be nulled, the audio processing device exits the calibration mode, at 716, and is ready to run in a use mode, at 718

FIG. 8 is a flowchart of a second particular embodiment of a method of operation of an audio processing device. The method of FIG. 8 may be performed by the audio processing device 140 of FIG. 1, by the audio processing device 202 of FIG. 2, 3 or 5, by the audio processing device 402 of FIG. 4 or 6, or a combination thereof.

The method includes, at 802, activating a use mode of the audio processing device (e.g., operating the audio processing device in a use mode of operation). The method also includes, at 804, activating echo cancellers, such as echo cancellation circuits of the echo processing component 613 of FIG. 6. The method also includes, at 806, estimating a target direction of arrival (DOA) of a near-end user (e.g., the user 122 of FIG. 1). Directions of arrival (DOAs) of interferers may also be determined if interferers are present.

The method may include, at 808, determining whether the target DOA coincides with a stored DOA for an audio output device. The stored DOAs may have been determined during operation of the audio processing device in a calibration mode. When the target DOA does not coincide with a stored DOA for any audio output device, the method includes, at 810, generating nulls for one or more audio output devices using the stored DOAs. In a particular embodiment, nulls may be generated for each front facing audio output device, where front facing refers to having a direct acoustic path (as opposed to a reflected acoustic path) from the audio output device to a microphone array. To illustrate, in FIG. 1, there is a direct acoustic path between the loudspeaker 106 and the microphone array 130, but there is not a direct acoustic path between the right loudspeaker 105 and the microphone array 130.

The method also includes, at 812, generating a tracking beam for the target DOA. The tracking beam may improve reception and/or processing of audio data associated with acoustic signals from the target DOA, for example, to improve processing of voice input from the user. The method may also include outputting (e.g., sending) a pass indicator for nullforming, at 814. The pass indicator may be provided to the echo cancellers to indicate that a null has been formed in audio data provided to the echo cancellers, where the null corresponds to the DOA of a particular audio output device. When multiple audio output devices are to be nulled, multiple pass indicators may be provided to the echo cancellers, one for each audio output device to be nulled. Alternately, a single pass indicator may be provided to the echo cancellers to indicate that nulls have been formed corresponding to each of the audio output devices to be nulled. The echo cancellers may include linear echo cancellers (e.g., adaptive filters), non-linear echo cancellers (e.g., EC PP), or both. In an embodiment that includes linear echo cancellers, the pass indicator may be used to indicate that echo associated with the particular audio output device has been removed via beamforming; accordingly, no linear echo cancellation of the signal associated with the particular audio output device may be performed by the echo cancellers. The method then proceeds to run a subsequent frame of audio data, at 816.

When the target DOA coincides with a stored DOA for any audio output device, at 808, the method includes, at 820, generating nulls for one or more audio output devices that do not coincide with the target DOA using the stored DOAs. For example, referring to FIG. 1, if the user 122 moves a bit to his or her left, the user's DOA at the microphone array 130 will coincide with the DOA of the loudspeaker 108. In this example, the audio processing component 140 may form the nulls 150, 154 and 156 but not form the null 152 so that the null 152 does not suppress audio input from the user 122.

The method also includes, at 822, generating a tracking beam for the target DOA. The method may also include outputting (e.g., sending) a fail indicator for nullforming for the audio output device with a DOA that coincides with the target DOA, at 824. The fail indicator may be provided to the echo cancellers to indicate that at least one null that was to be formed has not been formed. In an embodiment that includes linear echo cancellers, the fail indicator may be used to indicate that echo associated with the particular audio output device has not been removed via beamforming; accordingly, linear echo cancellation of the signal associated with the particular audio output device may be performed by the echo cancellers. The method then proceeds to run a subsequent frame, at 816.

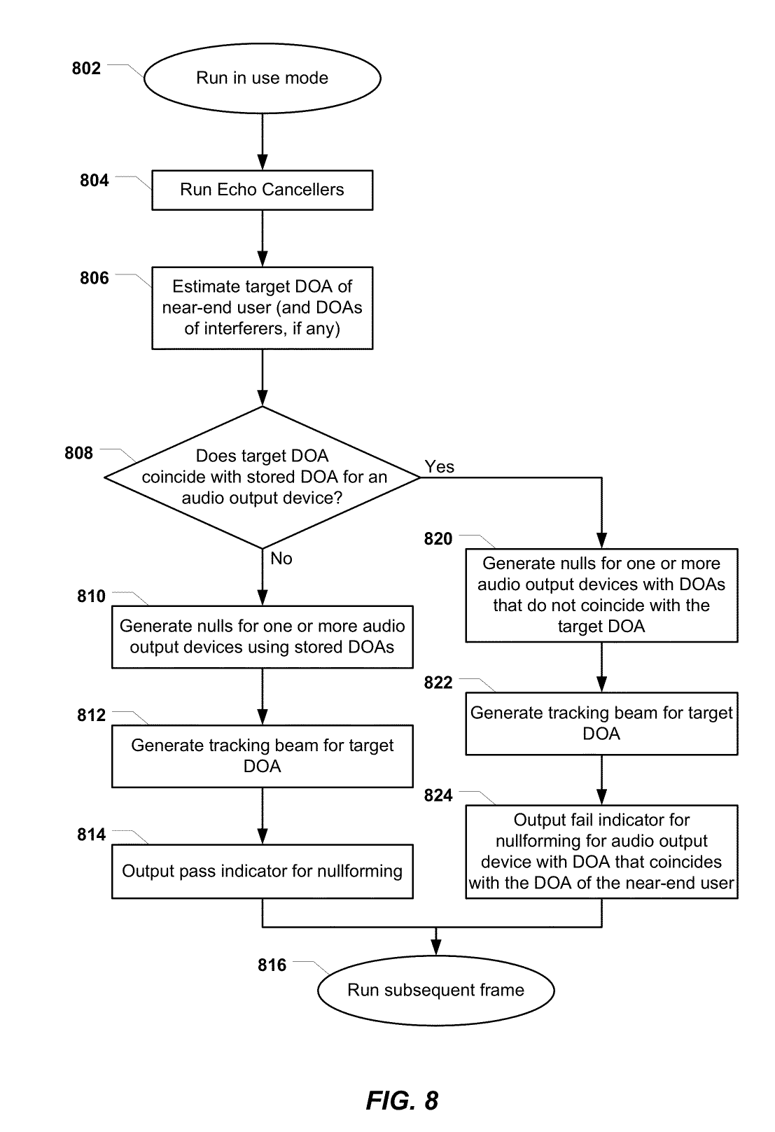

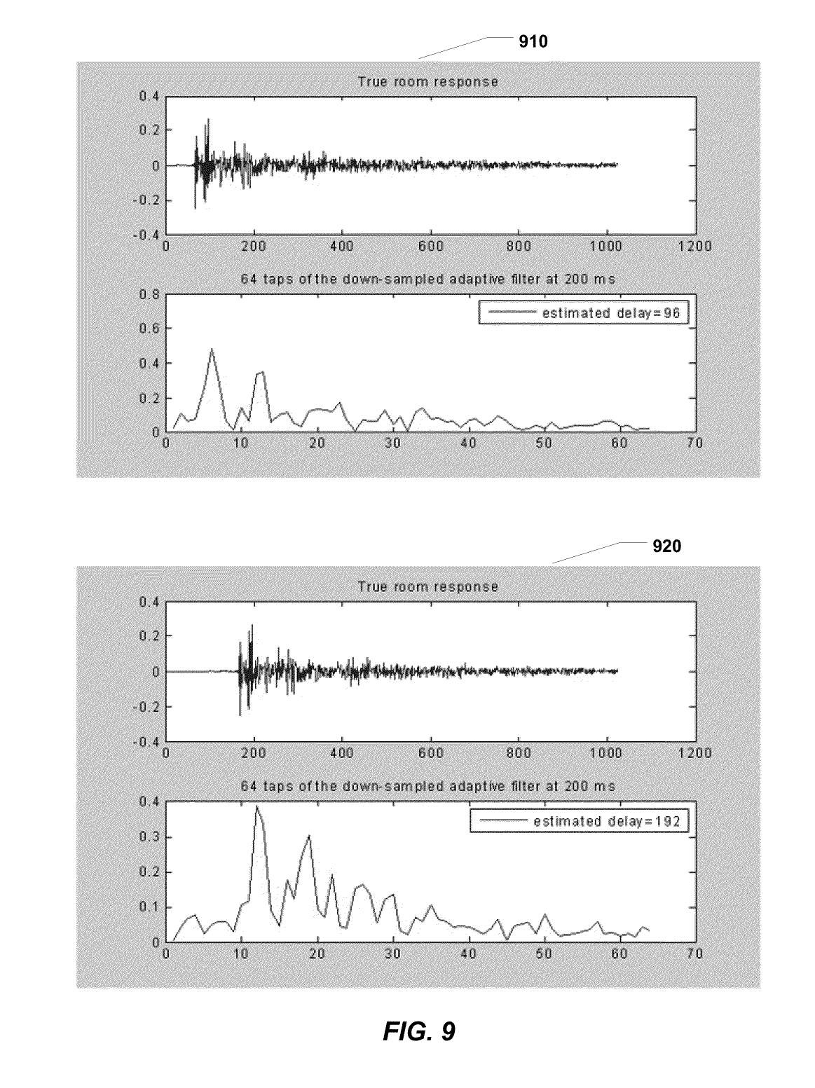

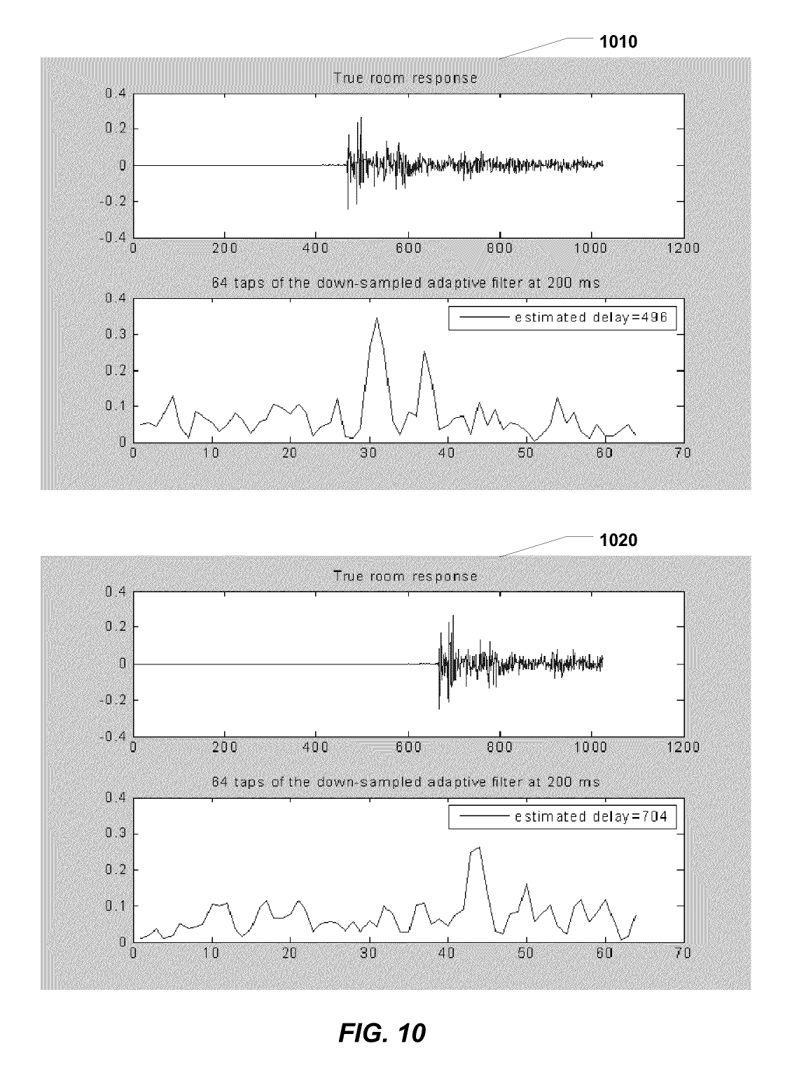

FIGS. 9 and 10 illustrate charts of simulated true room response delays and simulated down-sampled echo cancellation outputs associated with the simulated true room responses for a particular sub-band. The simulated true room responses correspond to a single sub-band of an audio signal received at a microphone, such as the microphone 206 of FIG. 2, in response to an output acoustic signal from a speaker, such as the speaker 204 of FIG. 2. The simulated true room responses show the single sub-band of the output acoustic signal as modified by a transfer function that is related to relative positions of the speaker and the microphone (and potentially to other factors, such as presence of objects that reflect the output acoustic signal). In a first chart 910, the microphone detects the sub-band after a first delay. By down-sampling an output of the echo cancellation device, an estimated delay of 96 milliseconds is calculated for the sub-band. In a particular embodiment, the estimated delay is based on a non-zero value of a tap weight in an adaptive filter (of an echo cancellation device). For example, a largest tap weight of the single sub-band of the output acoustic signal shown in the first chart 910 may be used to calculate the estimated delay. The estimated delay associated with the sub-band of the first chart 910 may be used with other estimated delays associated with other sub-bands to generate an estimated delay during the calibration mode of FIG. 2. For example, the estimated delay may correspond to a largest delay associated with one of the sub-bands, a smallest delay associated with one of the sub-bands, and average (e.g., mean, median or mode) delay of the sub-bands, or another function of the estimated delays of the sub-bands. A second chart 920, a third chart 1010 of FIG. 10, and a fourth chart 1020 of FIG. 10 illustrate progressively larger delays associated with the sub-band in both the true room response and the simulated down-sampled echo cancellation outputs.

It is a challenge to provide a method for estimating a three-dimensional direction of arrival (DOA) for each frame of an audio signal for concurrent multiple sound events that is sufficiently robust under background noise and reverberation. Robustness can be improved by increasing the number of reliable frequency bins. It may be desirable for such a method to be suitable for arbitrarily shaped microphone array geometry, such that specific constraints on microphone geometry may be avoided. A pair-wise 1-D approach as described herein can be appropriately incorporated into any geometry.

Such an approach may be implemented to operate without a microphone placement constraint. Such an approach may also be implemented to track sources using available frequency bins up to Nyquist frequency and down to a lower frequency (e.g., by supporting use of a microphone pair having a larger inter-microphone distance). Rather than being limited to a single pair of microphones for tracking, such an approach may be implemented to select a best pair of microphones among all available pairs of microphones. Such an approach may be used to support source tracking even in a far-field scenario, up to a distance of three to five meters or more, and to provide a much higher DOA resolution. Other potential features include obtaining a 2-D representation of an active source. For best results, it may be desirable that each source is a sparse broadband audio source and that each frequency bin is mostly dominated by no more than one source.

For a signal received by a pair of microphones directly from a point source in a particular DOA, the phase delay differs for each frequency component and also depends on the spacing between the microphones. The observed value of the phase delay at a particular frequency bin may be calculated as the inverse tangent of the ratio of the imaginary term of the complex FFT coefficient to the real term of the complex FFT coefficient. As shown in FIG. 11A, the phase delay value Δφ_{f} at a particular frequency f may be related to a source DOA under a far-field (i.e., plane-wave) assumption as

$${Δϕ}_{f} = 2 π f \frac{d sin θ}{c} ,$$

where d denotes the distance between the microphones (in m), θ denotes the angle of arrival (in radians) relative to a direction that is orthogonal to the array axis, f denotes frequency (in Hz), and c denotes the speed of sound (in m/s). For the ideal case of a single point source with no reverberation, the ratio of phase delay to frequency

$$\frac{Δϕ}{f}$$

will have the same value

$$2 π \frac{d sin θ}{c}$$

over all frequencies.

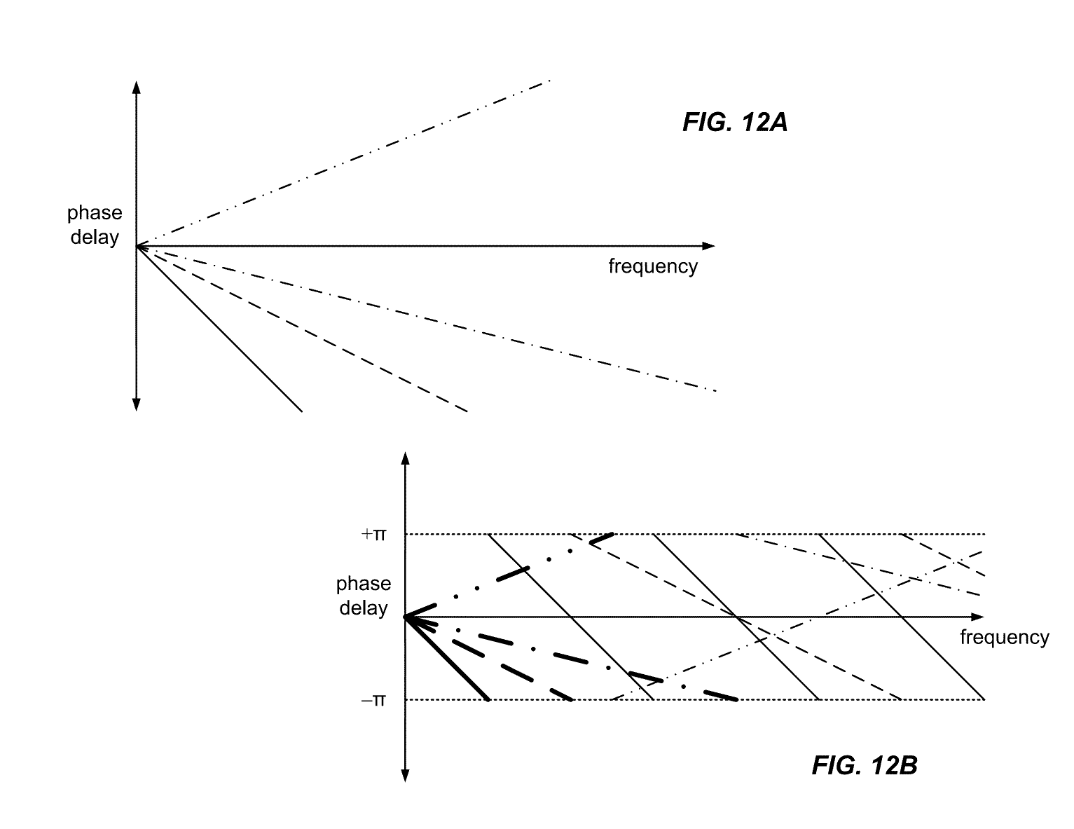

Such an approach may be limited in practice by the spatial aliasing frequency for the microphone pair, which may be defined as the frequency at which the wavelength of the signal is twice the distance d between the microphones. Spatial aliasing causes phase wrapping, which puts an upper limit on the range of frequencies that may be used to provide reliable phase delay measurements for a particular microphone pair. FIG. 12A shows plots of unwrapped phase delay vs. frequency for four different DOAs, and FIG. 12B shows plots of wrapped phase delay vs. frequency for the same DOAs, where the initial portion of each plot (i.e., until the first wrapping occurs) are shown in bold. Attempts to extend the useful frequency range of phase delay measurement by unwrapping the measured phase are typically unreliable.

Instead of phase unwrapping, a proposed approach compares the phase delay as measured (e.g., wrapped) with pre-calculated values of wrapped phase delay for each of an inventory of DOA candidates. FIG. 13A shows such an example that includes angle-vs.-frequency plots of the (noisy) measured phase delay values 215 (gray) and the phase delay values 215 for two DOA candidates of the inventory (solid and dashed lines), where phase is wrapped to the range of pi to minus pi. The DOA candidate that is best matched to the signal as observed may then be determined by calculating, for each DOA candidate θᵢ, a corresponding error eᵢ between the phase delay values 215 Δφᵢ_{_{f}} for the i-th DOA candidate and the observed phase delay values 215 Δφ_{ob}_{_{f}} over a range of frequency components f, and identifying the DOA candidate value that corresponds to the minimum error. In one example, the error eᵢ is expressed as ∥Δφ_{ob}_{_{f}}−Δφᵢ_{_{f}}∥_{f}², i.e. as the sum

eᵢ=Σ_{fεF}(Δφ_{ob}_{_{f}}−Δφᵢ_{_{f}})²

of the squared differences between the observed and candidate phase delay values 215 over a desired range or other set F of frequency components. The phase delay values 215 Δφᵢ_{_{f}} for each DOA candidate θᵢ may be calculated before run-time (e.g., during design or manufacture), according to known values of c and d and the desired range of frequency components f, and retrieved from storage during use of the device. Such a pre-calculated inventory may be configured to support a desired angular range and resolution (e.g., a uniform resolution, such as one, two, five, or ten degrees; or a desired nonuniform resolution) and a desired frequency range and resolution (which may also be uniform or nonuniform).

It may be desirable to calculate the error eᵢ across as many frequency bins as possible to increase robustness against noise. For example, it may be desirable for the error calculation to include terms from frequency bins that are beyond the spatial aliasing frequency. In a practical application, the maximum frequency bin may be limited by other factors, which may include available memory, computational complexity, strong reflection by a rigid body at high frequencies, etc.

A speech signal is typically sparse in the time-frequency domain. If the sources are disjoint in the frequency domain, then two sources can be tracked at the same time. If the sources are disjoint in the time domain, then two sources can be tracked at the same frequency. It may be desirable for the array to include a number of microphones that is at least equal to the number of different source directions to be distinguished at any one time. The microphones may be omnidirectional (e.g., as may be typical for a cellular telephone or a dedicated conferencing device) or directional (e.g., as may be typical for a device such as a set-top box).

Such multichannel processing is generally applicable, for example, to source tracking for speakerphone applications. Such a technique may be used to calculate a DOA estimate for a frame of a received multichannel signal. Such an approach may calculate, at each frequency bin, the error for each candidate angle with respect to the observed angle, which is indicated by the phase delay. The target angle at that frequency bin is the candidate having the minimum error. In one example, the error is then summed across the frequency bins to obtain a measure of likelihood for the candidate. In another example, one or more of the most frequently occurring target DOA candidates across all frequency bins is identified as the DOA estimate (or estimates) for a given frame.

Such a method may be applied to obtain instantaneous tracking results (e.g., with a delay of less than one frame). The delay is dependent on the FFT size and the degree of overlap. For example, for a 512-point FFT with a 50% overlap and a sampling frequency of 16 kHz, the resulting 256-sample delay corresponds to sixteen milliseconds. Such a method may be used to support differentiation of source directions typically up to a source-array distance of two to three meters, or even up to five meters.

The error may also be considered as a variance (i.e., the degree to which the individual errors deviate from an expected value). Conversion of the time-domain received signal into the frequency domain (e.g., by applying an FFT) has the effect of averaging the spectrum in each bin. This averaging is even more obvious if a sub-band representation is used (e.g., mel scale or Bark scale). Additionally, it may be desirable to perform time-domain smoothing on the DOA estimates (e.g., by applying as recursive smoother, such as a first-order infinite-impulse-response filter).

It may be desirable to reduce the computational complexity of the error calculation operation (e.g., by using a search strategy, such as a binary tree, and/or applying known information, such as DOA candidate selections from one or more previous frames).

Even though the directional information may be measured in terms of phase delay, it is typically desired to obtain a result that indicates source DOA. Consequently, it may be desirable to calculate the error in terms of DOA rather than in terms of phase delay.

An expression of error eᵢ in terms of DOA may be derived by assuming that an expression for the observed wrapped phase delay as a function of DOA, such as

$${Ψ}_{fwr} ( θ ) = mod ( - 2 π f \frac{d sin θ}{c} + π , 2 π ) - π$$

is equivalent to a corresponding expression for unwrapped phase delay as a function of DOA, such as

$${Ψ}_{fun} ( θ ) = - 2 π f \frac{d sin θ}{c}$$

except near discontinuities that are due to phase wrapping. The error eᵢ may then be expressed as

eᵢ=∥ψ_{fwr}(θ_{ob})−ψ_{fwr}(θᵢ)∥_{f}²≡∥ψ_{fun}(θ_{ob})−ψ_{fun}(θᵢ)∥_{f}²

where the difference between the observed and candidate phase delay at frequency f is expressed in terms of DOA as

$${Ψ}_{fun} ( {θ}_{ob} ) - {Ψ}_{fun} ( {θ}_{i} ) = \frac{- 2 π fd}{c} ( sin {θ}_{{ob}_{f}} - sin {θ}_{i} )$$

A Taylor series expansion may be performed to obtain the following first-order approximation:

$$\frac{- 2 π fd}{c} ( sin {θ}_{{ob}_{f}} - sin {θ}_{i} ) \approx ( {θ}_{{ob}_{f}} - {θ}_{i} ) \frac{- 2 π fd}{c} cos {θ}_{i}$$

which is used to obtain an expression of the difference between the DOA θ_{ob}_{_{f}} as observed at frequency f and DOA candidate θᵢ:

$$( {θ}_{{ob}_{f}} - {θ}_{i} ) ≅ \frac{{Ψ}_{fun} ( {θ}_{ob} ) - {Ψ}_{fun} ( {θ}_{i} )}{\frac{2 π fd}{c} cos {θ}_{i}}$$

This expression may be used, with the assumed equivalence of observed wrapped phase delay to unwrapped phase delay, to express error eᵢ in terms of DOA:

$${e}_{i} = {‖ {θ}_{ob} - θ ‖}_{f}^{2} ≅ \frac{{‖ {Ψ}_{fwr} ( {θ}_{ob} ) - {Ψ}_{fwr} ( {θ}_{i} ) ‖}_{f}^{2}}{{‖ \frac{2 π fd}{c} cos {θ}_{i} ‖}_{f}^{2}}$$

where the values of [ψ_{fwr}(θ_{ob}), ψ_{fwr}(θᵢ)] are defined as [Δφ_{ob}_{_{f}},Δφᵢ_{_{f}}].

To avoid division with zero at the endfire directions (θ=+/−90°), it may be desirable to perform such an expansion using a second-order approximation instead, as in the following:

$$\vert {θ}_{ob} - {θ}_{i} \vert ≅ \{ \begin{matrix}\vert - C / B \vert , & {θ}_{i} = 0 ( broadside ) \\ \vert \frac{- B + \sqrt{{B}^{2} - 4 AC}}{2 A} \vert , & otherwise ,\end{matrix} \\ where A = \frac{π fd sin {θ}_{i}}{c} , B = \frac{- 2 π fd cos {θ}_{i}}{c} , and \\ C = - ( {Ψ}_{fun} ( {θ}_{ob} ) - {Ψ}_{fun} ( {θ}_{i} ) )$$

As in the first-order example above, this expression may be used, with the assumed equivalence of observed wrapped phase delay to unwrapped phase delay, to express error eᵢ in terms of DOA as a function of the observed and candidate wrapped phase delay values 215.

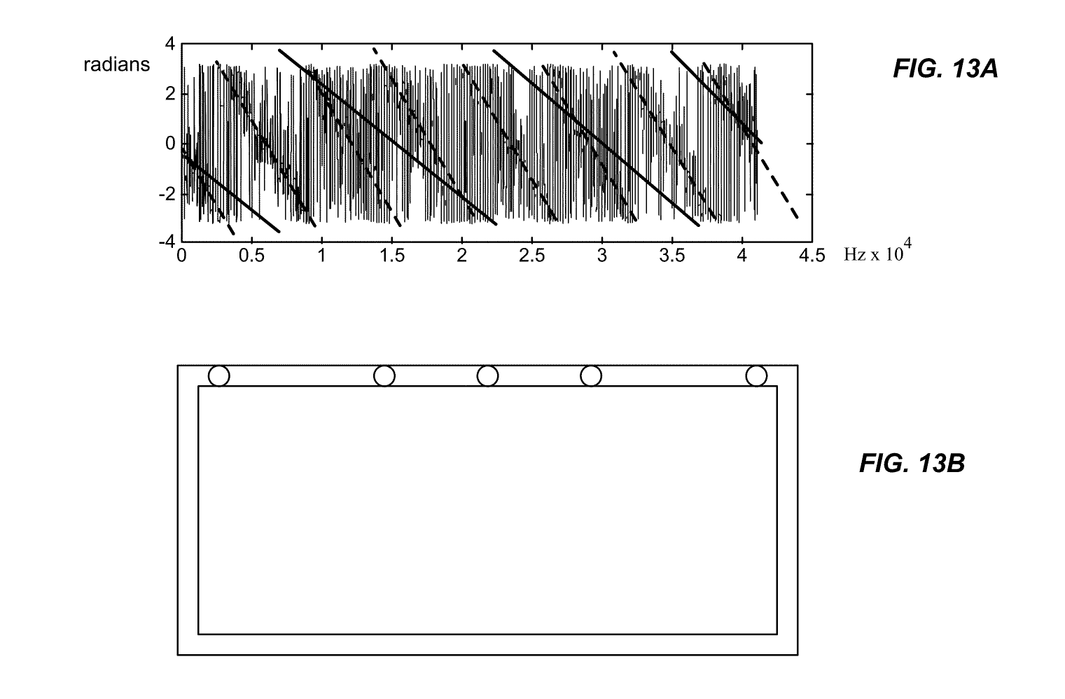

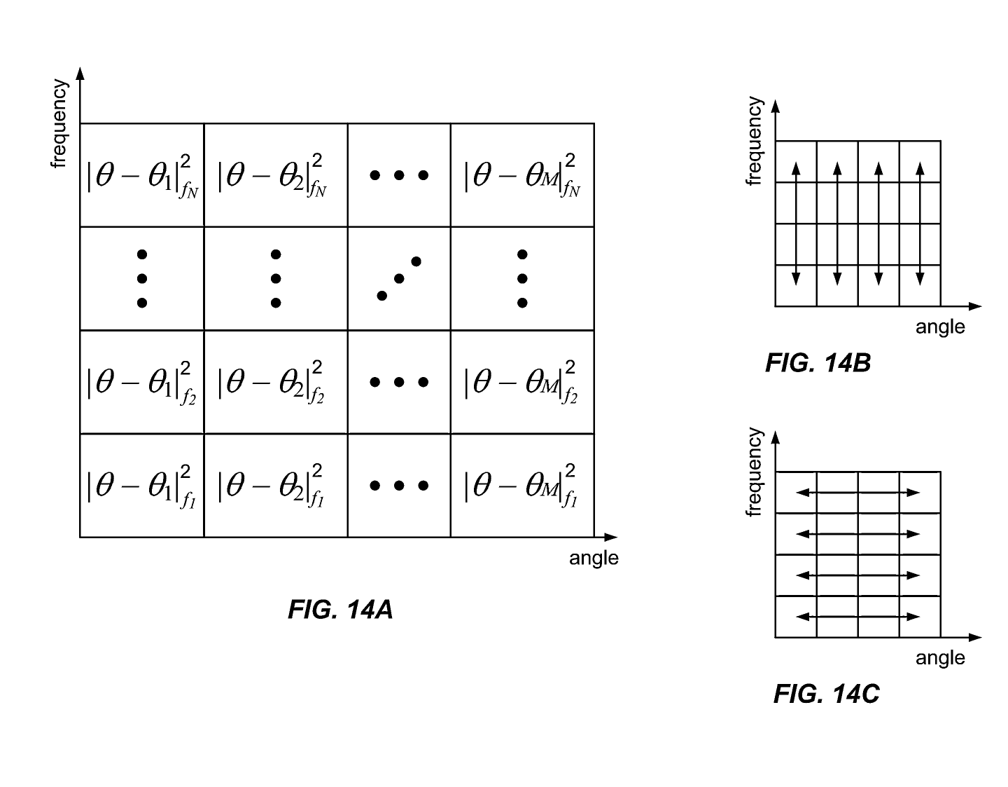

As shown in FIG. 14A, a difference between observed and candidate DOA for a given frame of the received signal may be calculated in such manner at each of a plurality of frequencies f of the received microphone signals (e.g., ∀fεF) and for each of a plurality of DOA candidates θᵢ. As demonstrated in FIG. 14B, a DOA estimate for a given frame may be determined by summing the squared differences for each candidate across all frequency bins in the frame to obtain the error eᵢ and selecting the DOA candidate having the minimum error. Alternatively, as demonstrated in FIG. 14C, such differences may be used to identify the best-matched (e.g., minimum squared difference) DOA candidate at each frequency. A DOA estimate for the frame may then be determined as the most frequent DOA across all frequency bins.

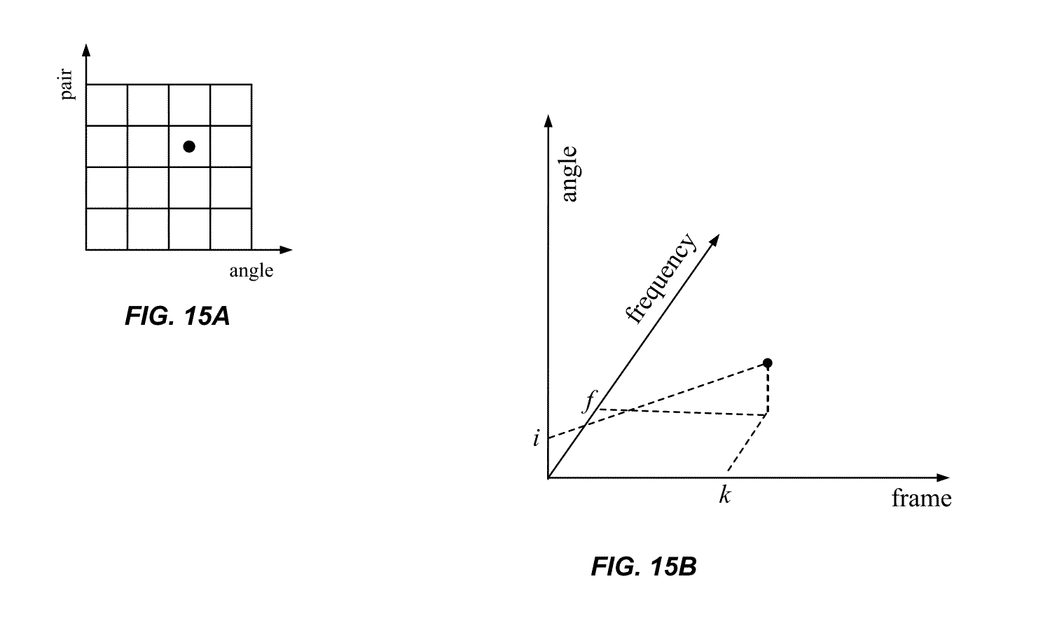

As shown in FIG. 15B, an error term may be calculated for each candidate angle i and each of a set F of frequencies for each frame k. It may be desirable to indicate a likelihood of source activity in terms of a calculated DOA difference or error. One example of such a likelihood L may be expressed, for a particular frame, frequency, and angle, as

$$L ( i , f , k ) = \frac{1}{{\vert {θ}_{ob} - {θ}_{i} \vert}_{f , k}^{2}} \qquad ( 1 )$$

For expression (1), an extremely good match at a particular frequency may cause a corresponding likelihood to dominate all others. To reduce this susceptibility, it may be desirable to include a regularization term λ, as in the following expression:

$$L ( i , f , k ) = \frac{1}{{\vert {θ}_{ob} - {θ}_{i} \vert}_{f , k}^{2} + λ} \qquad ( 2 )$$

Speech tends to be sparse in both time and frequency, such that a sum over a set of frequencies F may include results from bins that are dominated by noise. It may be desirable to include a bias term β, as in the following expression:

$$L ( i , f , k ) = \frac{1}{{\vert {θ}_{ob} - {θ}_{i} \vert}_{f , k}^{2} + λ} - β \qquad ( 3 )$$

The bias term, which may vary over frequency and/or time, may be based on an assumed distribution of the noise (e.g., Gaussian). Additionally or alternatively, the bias term may be based on an initial estimate of the noise (e.g., from a noise-only initial frame). Additionally or alternatively, the bias term may be updated dynamically based on information from noise-only frames, as indicated, for example, by a voice activity detection module.

The frequency-specific likelihood results may be projected onto a (frame, angle) plane to obtain a DOA estimation per frame

$${θ}_{{est}_{{k}_{i}}} {max}_{{\sum }_{f ε F} L ( i , f , k )}$$

that is robust to noise and reverberation because only target dominant frequency bins contribute to the estimate. In this summation, terms in which the error is large have values that approach zero and thus become less significant to the estimate. If a directional source is dominant in some frequency bins, the error value at those frequency bins will be nearer to zero for that angle. Also, if another directional source is dominant in other frequency bins, the error value at the other frequency bins will be nearer to zero for the other angle.

The likelihood results may also be projected onto a (frame, frequency) plane to indicate likelihood information per frequency bin, based on directional membership (e.g., for voice activity detection). This likelihood may be used to indicate likelihood of speech activity. Additionally or alternatively, such information may be used, for example, to support time- and/or frequency-selective masking of the received signal by classifying frames and/or frequency components according to their direction of arrival.

An anglogram representation is similar to a spectrogram representation. An anglogram may be obtained by plotting, at each frame, a likelihood of the current DOA candidate at each frequency.

A microphone pair having a large spacing is typically not suitable for high frequencies, because spatial aliasing begins at a low frequency for such a pair. A DOA estimation approach as described herein, however, allows the use of phase delay measurements beyond the frequency at which phase wrapping begins, and even up to the Nyquist frequency (i.e., half of the sampling rate). By relaxing the spatial aliasing constraint, such an approach enables the use of microphone pairs having larger inter-microphone spacings. As an array with a large inter-microphone distance typically provides better directivity at low frequencies than an array with a small inter-microphone distance, use of a larger array typically extends the range of useful phase delay measurements into lower frequencies as well.

The DOA estimation principles described herein may be extended to multiple microphone pairs in a linear array (e.g., as shown in FIG. 11B). One example of such an application for a far-field scenario is a linear array of microphones arranged along the margin of a television or other large-format video display screen (e.g., as shown in FIG. 13B). It may be desirable to configure such an array to have a nonuniform (e.g., logarithmic) spacing between microphones, as in the examples of FIGS. 11B and 13B.

For a far-field source, the multiple microphone pairs of a linear array will have essentially the same DOA. Accordingly, one option is to estimate the DOA as an average of the DOA estimates from two or more pairs in the array. However, an averaging scheme may be affected by mismatch of even a single one of the pairs, which may reduce DOA estimation accuracy. Alternatively, it may be desirable to select, from among two or more pairs of microphones of the array, the best microphone pair for each frequency (e.g., the pair that gives the minimum error eᵢ at that frequency), such that different microphone pairs may be selected for different frequency bands. At the spatial aliasing frequency of a microphone pair, the error will be large. Consequently, such an approach will tend to automatically avoid a microphone pair when the frequency is close to its wrapping frequency, thus avoiding the related uncertainty in the DOA estimate. For higher-frequency bins, a pair having a shorter distance between the microphones will typically provide a better estimate and may be automatically favored, while for lower-frequency bins, a pair having a larger distance between the microphones will typically provide a better estimate and may be automatically favored. In the four-microphone example shown in FIG. 11B, six different pairs of microphones are possible (i.e.,

$$( \begin{matrix}4 \\ 2\end{matrix} ) = 6 )$$

In one example, the best pair for each axis is selected by calculating, for each frequency f, P×I values, where P is the number of pairs, I is the size of the inventory, and each value eₚᵢ is the squared absolute difference between the observed angle θ_{pf} (for pair p and frequency f) and the candidate angle θ_{if}. For each frequency f, the pair p that corresponds to the lowest error value eₚᵢ is selected. This error value also indicates the best DOA candidate θᵢ at frequency f (as shown in FIG. 15A).

The signals received by a microphone pair may be processed as described herein to provide an estimated DOA, over a range of up to 180 degrees, with respect to the axis of the microphone pair. The desired angular span and resolution may be arbitrary within that range (e.g. uniform (linear) or nonuniform (nonlinear), limited to selected sectors of interest, etc.). Additionally or alternatively, the desired frequency span and resolution may be arbitrary (e.g. linear, logarithmic, mel-scale, Bark-scale, etc.).

In the model shown in FIG. 11B, each DOA estimate between 0 and +/−90 degrees from a microphone pair indicates an angle relative to a plane that is orthogonal to the axis of the pair. Such an estimate describes a cone around the axis of the pair, and the actual direction of the source along the surface of this cone is indeterminate. For example, a DOA estimate from a single microphone pair does not indicate whether the source is in front of or behind the microphone pair. Therefore, while more than two microphones may be used in a linear array to improve DOA estimation performance across a range of frequencies, the range of DOA estimation supported by a linear array is typically limited to 180 degrees.

The DOA estimation principles described herein may also be extended to a two-dimensional (2-D) array of microphones. For example, a 2-D array may be used to extend the range of source DOA estimation up to a full 360 degrees (e.g., providing a similar range as in applications such as radar and biomedical scanning). Such an array may be used in a particular embodiment, for example, to support good performance even for arbitrary placement of the telephone relative to one or more sources.

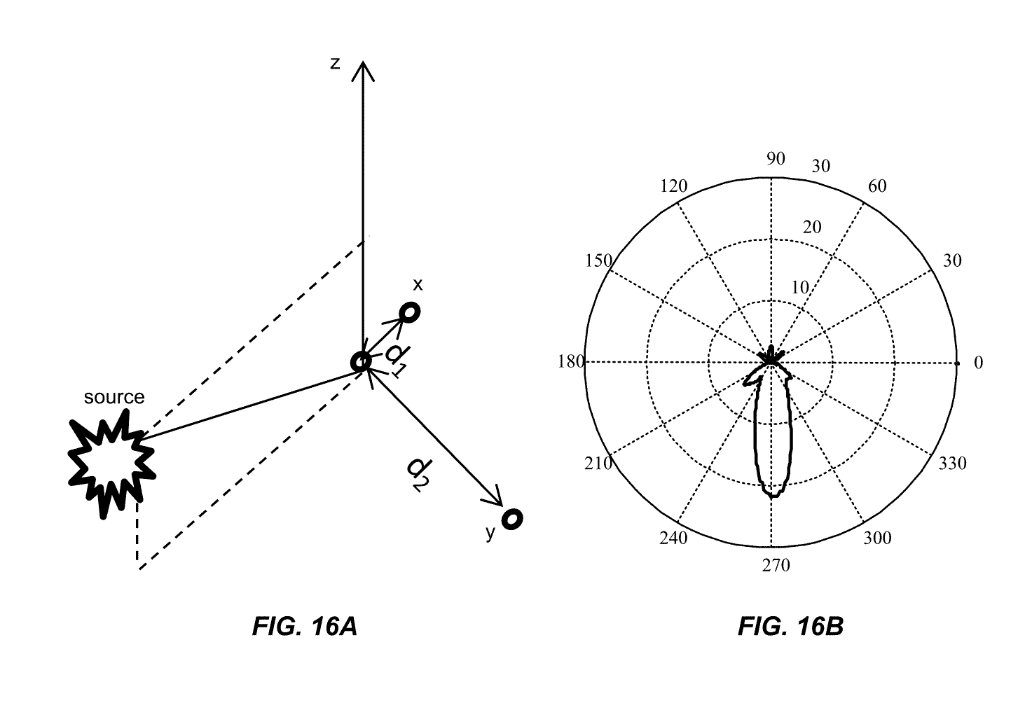

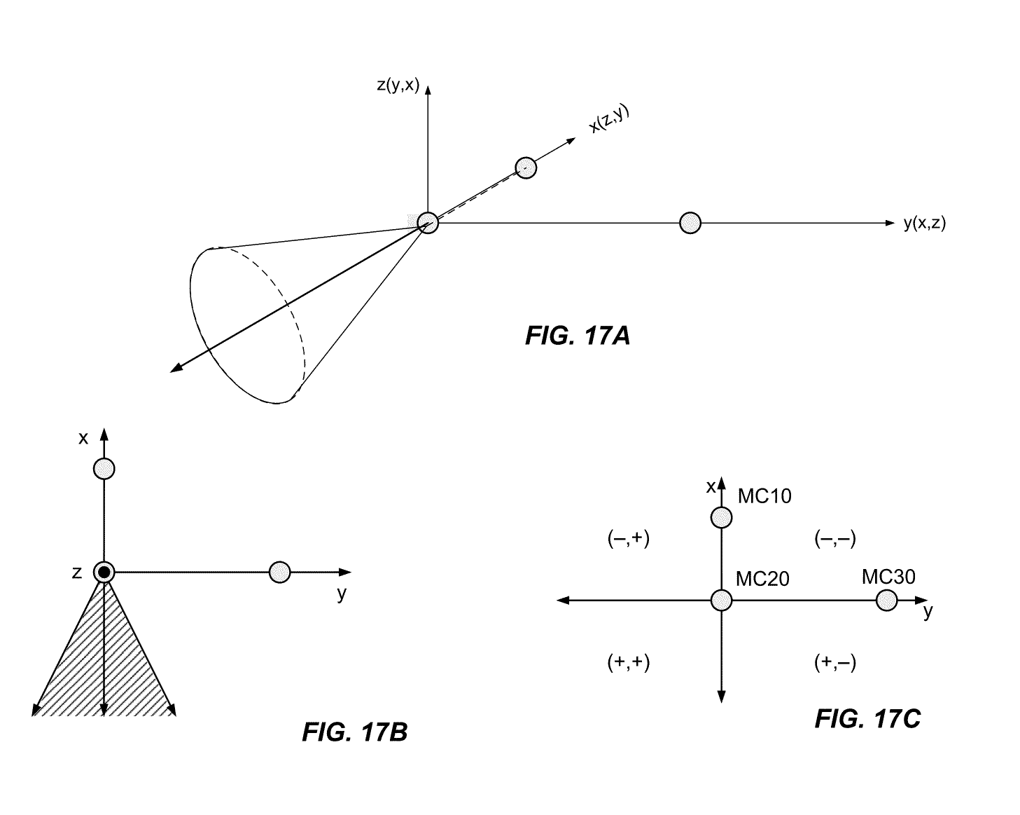

The multiple microphone pairs of a 2-D array typically will not share the same DOA, even for a far-field point source. For example, source height relative to the plane of the array (e.g., in the z-axis) may play an important role in 2-D tracking. FIG. 16A shows an example of an embodiment in which the x-y plane as defined by the microphone axes is parallel to a surface (e.g., a tabletop) on which the microphone array is placed. In this example, the source is a person speaking from a location that is along the x axis but is offset in the direction of the z axis (e.g., the speaker's mouth is above the tabletop). With respect to the x-y plane as defined by the microphone array, the direction of the source is along the x axis, as shown in FIG. 16A. The microphone pair along the y axis estimates a DOA of the source as zero degrees from the x-z plane. Due to the height of the speaker above the x-y plane, however, the microphone pair along the x axis estimates a DOA of the source as 30 deg. from the x axis (i.e., 60 degrees from the y-z plane), rather than along the x axis. FIGS. 17A and 17B shows two views of the cone of confusion associated with this DOA estimate, which causes an ambiguity in the estimated speaker direction with respect to the microphone axis.

An expression such as

$$[ {tan}^{- 1} ( \frac{sin {θ}_{1}}{sin {θ}_{2}} ) , {tan}^{- 1} ( \frac{sin {θ}_{2}}{sin {θ}_{1}} ) ] , \qquad ( 4 )$$

where θ₁ and θ₂ are the estimated DOA for pair 1 and 2, respectively, may be used to project all pairs of DOAs to a 360° range in the plane in which the three microphones are located. Such projection may be used to enable tracking directions of active speakers over a 360° range around the microphone array, regardless of height difference. Applying the expression above to project the DOA estimates (0°, 60°) of FIG. 16A into the x-y plane produces

$$[ {tan}^{- 1} ( \frac{sin {0}^{∘}}{sin {60}^{∘}} ) , {tan}^{- 1} ( \frac{sin {60}^{∘}}{sin {0}^{∘}} ) ] = ( {0}^{∘} , {90}^{∘} ) ,$$

which may be mapped to a combined directional estimate (e.g., an azimuth) of 270° as shown in FIG. 16B.

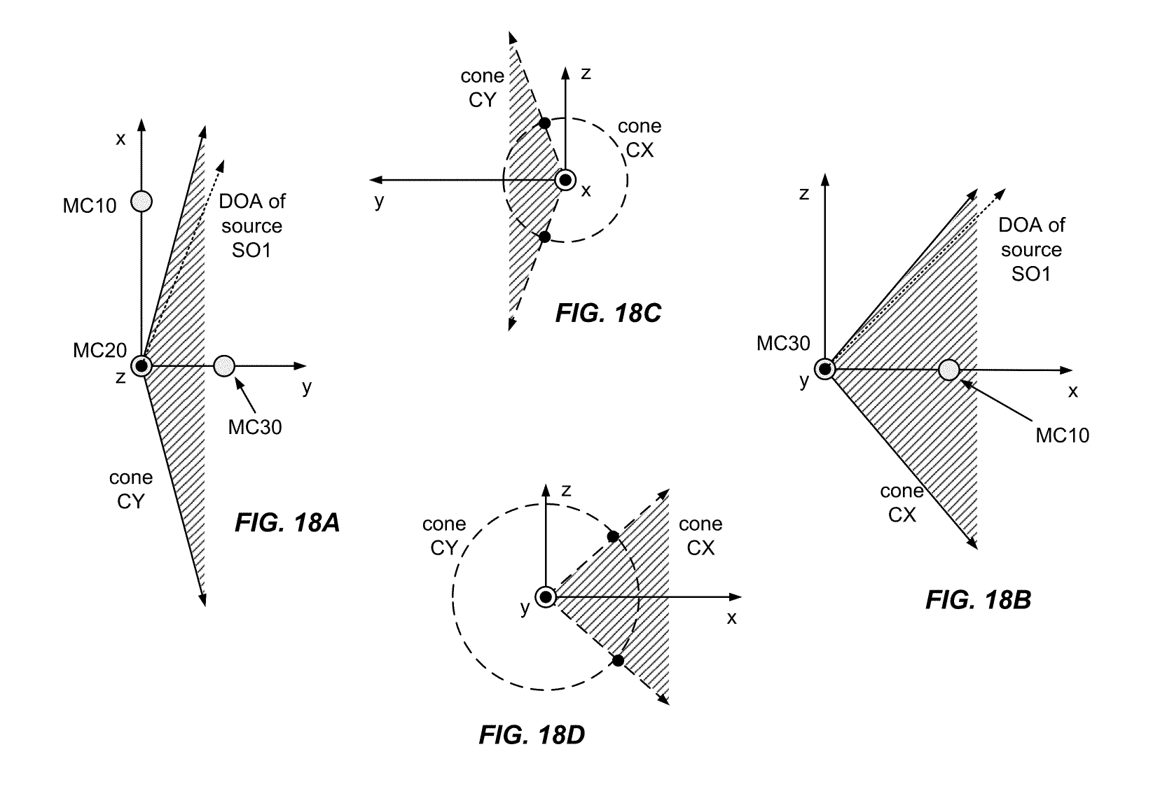

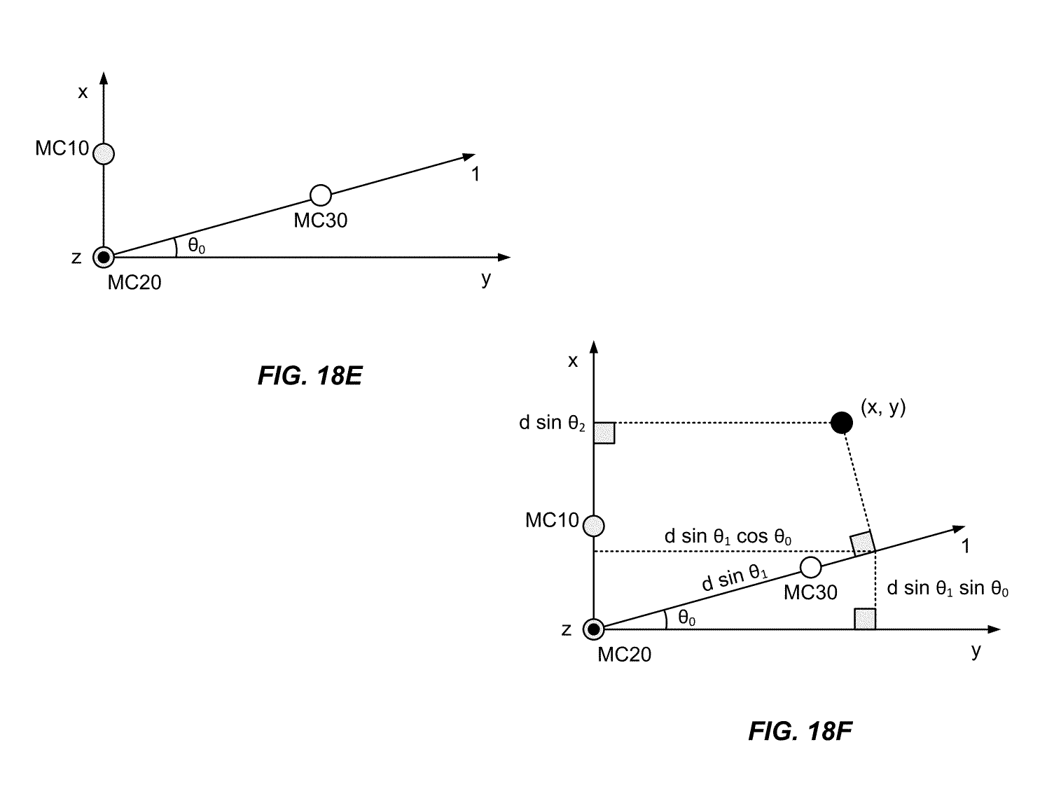

In a typical use case, the source will be located in a direction that is not projected onto a microphone axis. FIGS. 18A-18D show such an example in which the source is located above the plane of the microphones. In this example, the DOA of the source signal passes through the point (x,y,z)=(5,2,5). FIG. 18A shows the x-y plane as viewed from the +z direction, FIGS. 18B and 18D show the x-z plane as viewed from the direction of microphone MC30, and FIG. 18C shows the y-z plane as viewed from the direction of microphone MC10. The shaded area in FIG. 18A indicates the cone of confusion CY associated with the DOA θ₁ as observed by the y-axis microphone pair MC20-MC30, and the shaded area in FIG. 18B indicates the cone of confusion CX associated with the DOA θ₂ as observed by the x-axis microphone pair MC10-MC20. In FIG. 18C, the shaded area indicates cone CY, and the dashed circle indicates the intersection of cone CX with a plane that passes through the source and is orthogonal to the x axis. The two dots on this circle that indicate its intersection with cone CY are the candidate locations of the source. Likewise, in FIG. 18D the shaded area indicates cone CX, the dashed circle indicates the intersection of cone CY with a plane that passes through the source and is orthogonal to the y axis, and the two dots on this circle that indicate its intersection with cone CX are the candidate locations of the source. It may be seen that in this 2-D case, an ambiguity remains with respect to whether the source is above or below the x-y plane.

For the example shown in FIGS. 18A-18D, the DOA observed by the x-axis microphone pair MC10-MC20 is

$${θ}_{2} = {tan}^{- 1} ( - 5 / \sqrt{25 + 4} ) \approx - {42.9}^{∘}$$

and the DOA observed by the y-axis microphone pair MC20-MC30 is

$${θ}_{1} = {tan}^{- 1} ( - 2 / \sqrt{25 + 25} ) \approx - {15.8}^{∘} .$$

Using expression (4) to project these directions into the x-y plane produces the magnitudes (21.8°, 68.2°) of the desired angles relative to the x and y axes, respectively, which corresponds to the given source location (x,y,z)=(5,2,5). The signs of the observed angles indicate the x-y quadrant in which the source is located, as shown in FIG. 17C.

In fact, almost 3D information is given by a 2D microphone array, except for the up-down confusion. For example, the directions of arrival observed by microphone pairs MC10-MC20 and MC20-MC30 may also be used to estimate the magnitude of the angle of elevation of the source relative to the x-y plane. If d denotes the vector from microphone MC20 to the source, then the lengths of the projections of vector d onto the x-axis, the y-axis, and the x-y plane may be expressed as d sin(θ₂), d sin(θ₁) and d\sqrt{sin²(θ₁)+sin²(θ₂)} respectively. The magnitude of the angle of elevation may then be estimated as \hat{θ}ₕ=cos⁻¹\sqrt{sin²(θ₁)+sin²(θ₂)}.

Although the microphone pairs in the particular examples of FIGS. 16A-16B and 18A-18D have orthogonal axes, it is noted that for microphone pairs having non-orthogonal axes, expression (4) may be used to project the DOA estimates to those non-orthogonal axes, and from that point it is straightforward to obtain a representation of the combined directional estimate with respect to orthogonal axes. FIG. 18E shows an example of microphone array MC10-MC20-MC30 in which the axis 1 of pair MC20-MC30 lies in the x-y plane and is skewed relative to the y axis by a skew angle θ₀.

FIG. 18F shows an example of obtaining a combined directional estimate in the x-y plane with respect to orthogonal axes x and y with observations (θ₁, θ₂) from an array, as shown in FIG. 18E. If d denotes the vector from microphone MC20 to the source, then the lengths of the projections of vector d onto the x-axis and axis 1 may be expressed as d sin(θ₂) and d sin(θ₁) respectively. The vector (x,y) denotes the projection of vector d onto the x-y plane. The estimated value of x is known, and it remains to estimate the value of y.

The estimation of y may be performed using the projection p₁=(d sin θ₁ sin θ₀, d sin θ₁ cos θ₀) of vector (x,y) onto axis 1. Observing that the difference between vector (x,y) and vector p₁ is orthogonal to p₁, calculate y as

$$y = d \frac{sin {θ}_{1} - sin {θ}_{2} sin {θ}_{0}}{cos {θ}_{0}}$$

The desired angles of arrival in the x-y plane, relative to the orthogonal x and y axes, may then be expressed respectively as

$$( {tan}^{- 1} ( \frac{y}{x} ) , {tan}^{- 1} ( \frac{x}{y} ) ) = ( {tan}^{- 1} ( \frac{sin {θ}_{1} - sin {θ}_{2} sin {θ}_{0}}{sin {θ}_{2} cos {θ}_{0}} ) , {tan}^{- 1} ( \frac{sin {θ}_{2} cos {θ}_{0}}{sin {θ}_{1} - sin {θ}_{2} sin {θ}_{0}} ) )$$

Extension of DOA estimation to a 2-D array is typically well-suited to and sufficient for certain embodiments. However, further extension to an N-dimensional array is also possible and may be performed in a straightforward manner. For tracking applications in which one target is dominant, it may be desirable to select N pairs for representing N dimensions. Once a 2-D result is obtained with a particular microphone pair, another available pair can be utilized to increase degrees of freedom. For example, FIGS. 18A-18F illustrate use of observed DOA estimates from different microphone pairs in the x-y plane to obtain an estimate of the source direction as projected into the x-y plane. In the same manner, observed DOA estimates from an x-axis microphone pair and a z-axis microphone pair (or other pairs in the x-z plane) may be used to obtain an estimate of the source direction as projected into the x-z plane, and likewise for the y-z plane or any other plane that intersects three or more of the microphones.

Estimates of DOA error from different dimensions may be used to obtain a combined likelihood estimate, for example, using an expression such as

$$\frac{1}{( max ( {\vert θ - {θ}_{0 , 1} \vert}_{{( f , 1 )}^{′}}^{2} {\vert θ - {θ}_{0 , 2} \vert}_{( f , 2 )}^{2} + λ ) )}$$

$$or$$

$$\frac{1}{( mean ( {\vert θ - {θ}_{0 , 1} \vert}_{{( f , 1 )}^{′}}^{2} {\vert θ - {θ}_{0 , 2} \vert}_{( f , 2 )}^{2} + λ ) )}$$

where θ_{0,i} denotes the DOA candidate selected for pair i. Use of the maximum among the different errors may be desirable to promote selection of an estimate that is close to the cones of confusion of both observations, in preference to an estimate that is close to only one of the cones of confusion and may thus indicate a false peak. Such a combined result may be used to obtain a (frame, angle) plane, as described herein, and/or a (frame, frequency) plot, as described herein.

The DOA estimation principles described herein may be used to support selection among multiple users that are speaking. For example, location of multiple sources may be combined with a manual selection of a particular user that is speaking (e.g., push a particular button to select a particular corresponding user) or automatic selection of a particular user (e.g., by speaker recognition). In one such application, an audio processing device (such as the audio processing device of FIG. 1) is configured to recognize the voice of a particular user and to automatically select a direction corresponding to that voice in preference to the directions of other sources.

A source DOA may be easily defined in 1-D, e.g. from −90 deg. to +90 deg. For more than two microphones at arbitrary relative locations, it is proposed to use a straightforward extension of 1-D as described above, e.g. (θ₁, θ₂) in two-pair case in 2-D, (θ₁, θ₂, θ₃) in three-pair case in 3-D, etc.

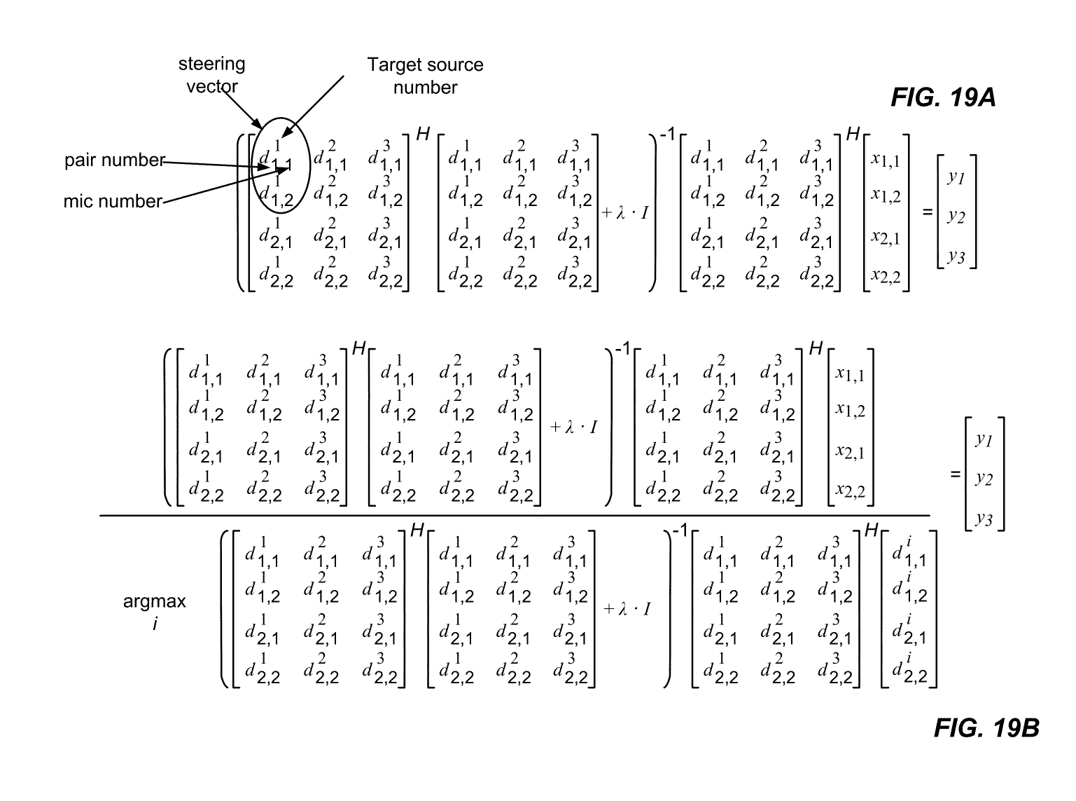

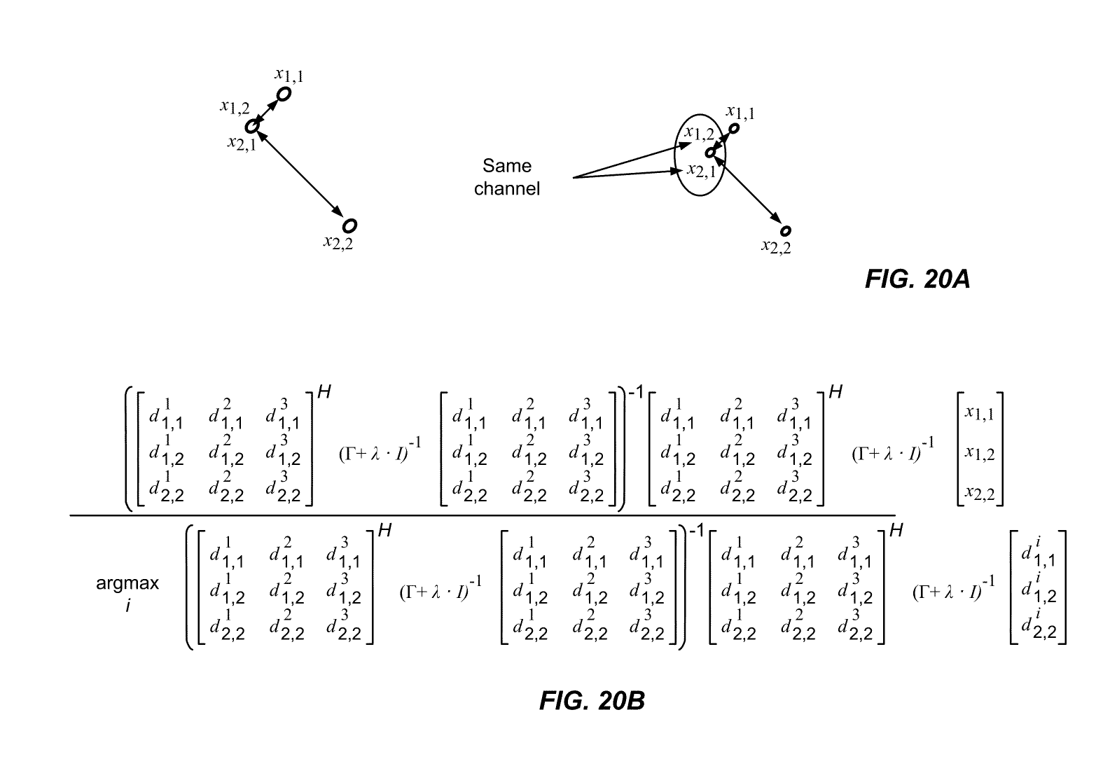

To apply spatial filtering to such a combination of paired 1-D DOA estimates, a beamformer/null beamformer (BFNF) as shown in FIG. 19A may be applied by augmenting the steering vector for each pair. In FIG. 19A, A^{H} denotes the conjugate transpose of A, x denotes the microphone channels, and y denotes the spatially filtered channels. Using a pseudo-inverse operation A⁺=(A^{H}A)⁻¹A^{H} as shown in FIG. 19A allows the use of a non-square matrix. For a three-microphone case (i.e., two microphone pairs) as illustrated in FIG. 20A, for example, the number of rows 2*2=4 instead of 3, such that the additional row makes the matrix non-square.

As the approach shown in FIG. 19A is based on robust 1-D DOA estimation, complete knowledge of the microphone geometry is not required, and DOA estimation using all microphones at the same time is also not required. Such an approach is well-suited for use with anglogram-based DOA estimation as described herein, although any other 1-D DOA estimation method can also be used. FIG. 19B shows an example of the BFNF as shown in FIG. 19A which also includes a normalization factor to prevent an ill-conditioned inversion at the spatial aliasing frequency.

FIG. 20B shows an example of a pair-wise (PW) normalized MVDR (minimum variance distortionless response) BFNF, in which the manner in which the steering vector (array manifold vector) is obtained differs from the conventional approach. In this case, a common channel is eliminated due to sharing of a microphone between the two pairs. The noise coherence matrix Γ may be obtained either by measurement or by theoretical calculation using a sin c function. It is noted that the examples of FIGS. 19A, 19B, and 20B may be generalized to an arbitrary number of sources N such that N<=M, where M is the number of microphones.

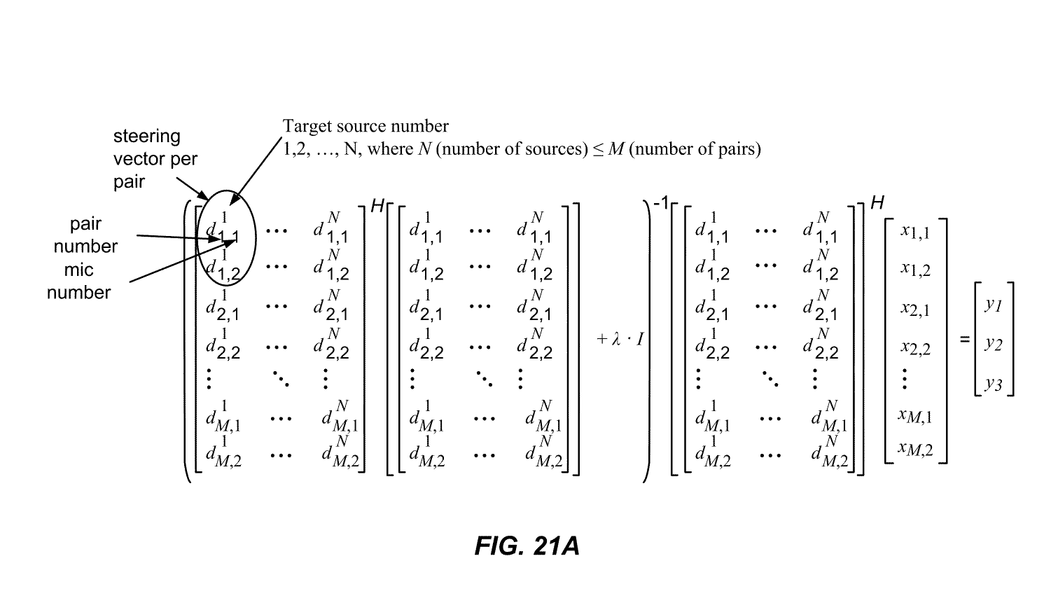

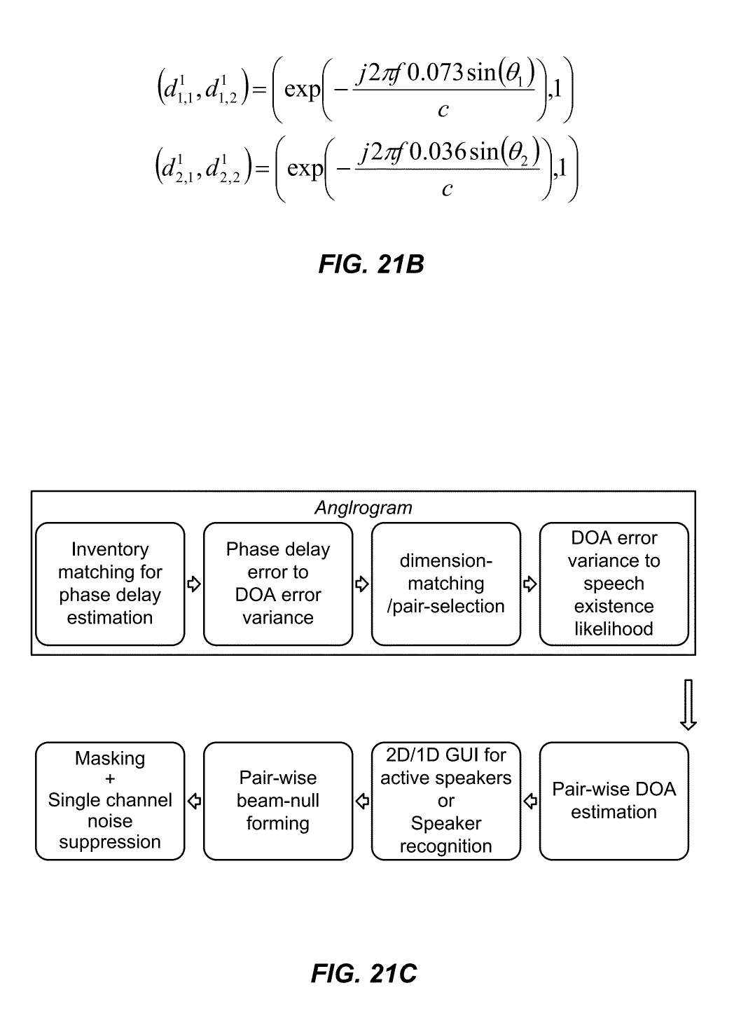

FIG. 21A shows another example that may be used if the matrix A^{H}A is not ill-conditioned, which may be determined using a condition number or determinant of the matrix. If the matrix is ill-conditioned, it may be desirable to bypass one microphone signal for that frequency bin for use as the source channel, while continuing to apply the method to spatially filter other frequency bins in which the matrix A^{H}A is not ill-conditioned. This option saves computation for calculating a denominator for normalization. The methods in FIGS. 19A-21A demonstrate BFNF techniques that may be applied independently at each frequency bin. The steering vectors are constructed using the DOA estimates for each frequency and microphone pair as described herein. For example, each element of the steering vector for pair p and source n for DOA θᵢ frequency f, and microphone number m (1 or 2) may be calculated as

$${d}_{p , m}^{n} = exp ( \frac{j ω {f}_{s} ( m - 1 ) {l}_{p}}{c} cos {θ}_{i} ) ,$$

where lₚ indicates the distance between the microphones of pair p, ω indicates the frequency bin number, and fₛ indicates the sampling frequency. FIG. 21B shows examples of steering vectors for an array as shown in FIG. 20A.

A PWBFNF scheme may be used for suppressing direct path of interferers up to the available degrees of freedom (instantaneous suppression without smooth trajectory assumption, additional noise-suppression gain using directional masking, additional noise-suppression gain using bandwidth extension). Single-channel post-processing of quadrant framework may be used for stationary noise and noise-reference handling.

It may be desirable to obtain instantaneous suppression but also to provide minimization of artifacts, such as musical noise. It may be desirable to maximally use the available degrees of freedom for BFNF. One DOA may be fixed across all frequencies, or a slightly mismatched alignment across frequencies may be permitted. Only the current frame may be used, or a feed-forward network may be implemented. The BFNF may be set for all frequencies in the range up to the Nyquist rate (e.g., except ill-conditioned frequencies). A natural masking approach may be used (e.g., to obtain a smooth natural seamless transition of aggressiveness).

FIG. 21C shows a flowchart for one example of an integrated method as described herein. This method includes an inventory matching task for phase delay estimation, a variance calculation task to obtain DOA error variance values, a dimension-matching and/or pair-selection task, and a task to map DOA error variance for the selected DOA candidate to a source activity likelihood estimate. The pair-wise DOA estimation results may also be used to track one or more active speakers, to perform a pair-wise spatial filtering operation, and or to perform time- and/or frequency-selective masking. The activity likelihood estimation and/or spatial filtering operation may also be used to obtain a noise estimate to support a single-channel noise suppression operation.

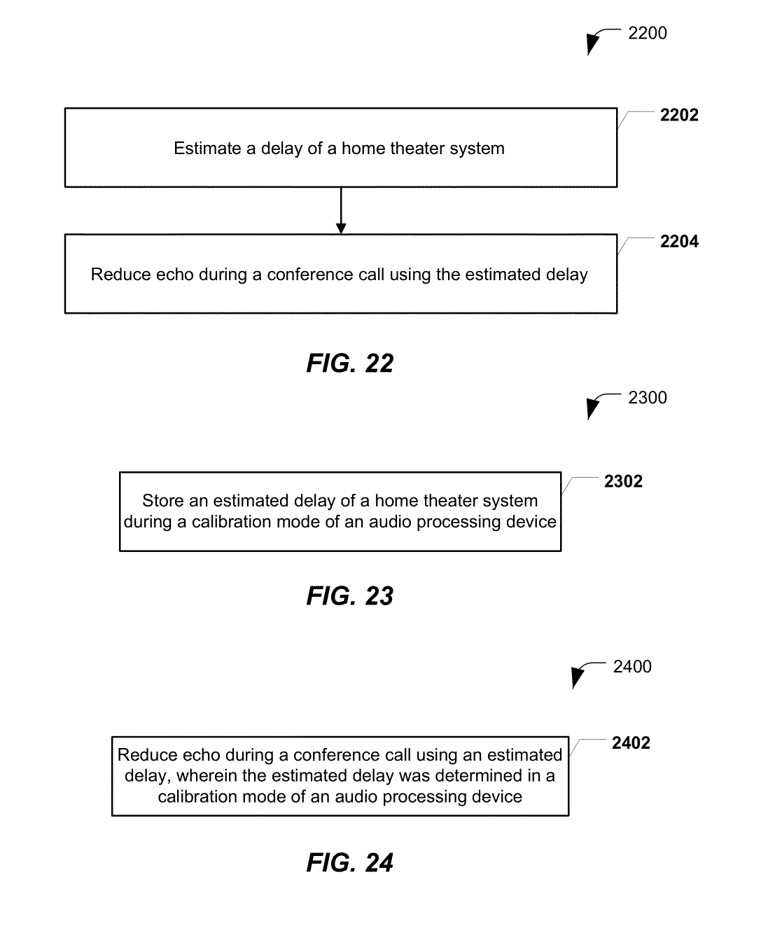

FIG. 22 is a flowchart of a third particular embodiment of a method of operation of an audio processing device. As described above, the audio processing device may be a component of a television (such as a “smart” television that includes a processor capable of executing a teleconferencing application) or another home theater component. The method 2200 includes, at 2202, estimating a delay of a home theater system. For example, the method 2200 may include estimating acoustic signal propagation delays, electrical signal propagation delays, or both. The method 2200 also includes, at 2204, reducing echo during a conference call using the estimated delay. For example, as explained with reference to FIGS. 2 and 5, a delay component may delay sending far end signals to an echo cancellation device.

FIG. 23 is a flowchart of a fourth particular embodiment of a method of operation of an audio processing device. As described above, the audio processing device may be a component of a television (such as a “smart” television that includes a processor capable of executing a teleconferencing application) or another home theater component. The method 2300 includes, at 2302, storing an estimated delay of a home theater system during a calibration mode of an audio processing device. For example, the method 2300 may include estimating acoustic signal propagation delays, electrical signal propagation delays, or both, associated with a home theater system. A delay value related to the estimated delay may be stored at a tunable delay component and subsequently used to delay sending far end signals to an echo cancellation device to reduce echo during a conference call.

FIG. 24 is a flowchart of a fifth particular embodiment of a method of operation of an audio processing device. As described above, the audio processing device may be a component of a television (such as a “smart” television that includes a processor capable of executing a teleconferencing application) or another home theater component. The method 2400 includes, at 2402, reducing echo during a conference call using an estimated delay, where the estimated delay was determined in operation of the audio processing device in a calibration mode. For example, during the calibration mode, acoustic signal propagation delays, electrical signal propagation delays, or both, associated with the audio processing device may be determined A delay value related to the estimated delay may be stored at a tunable delay component and subsequently used to delay sending far end signals to an echo cancellation device to reduce echo during a conference call.

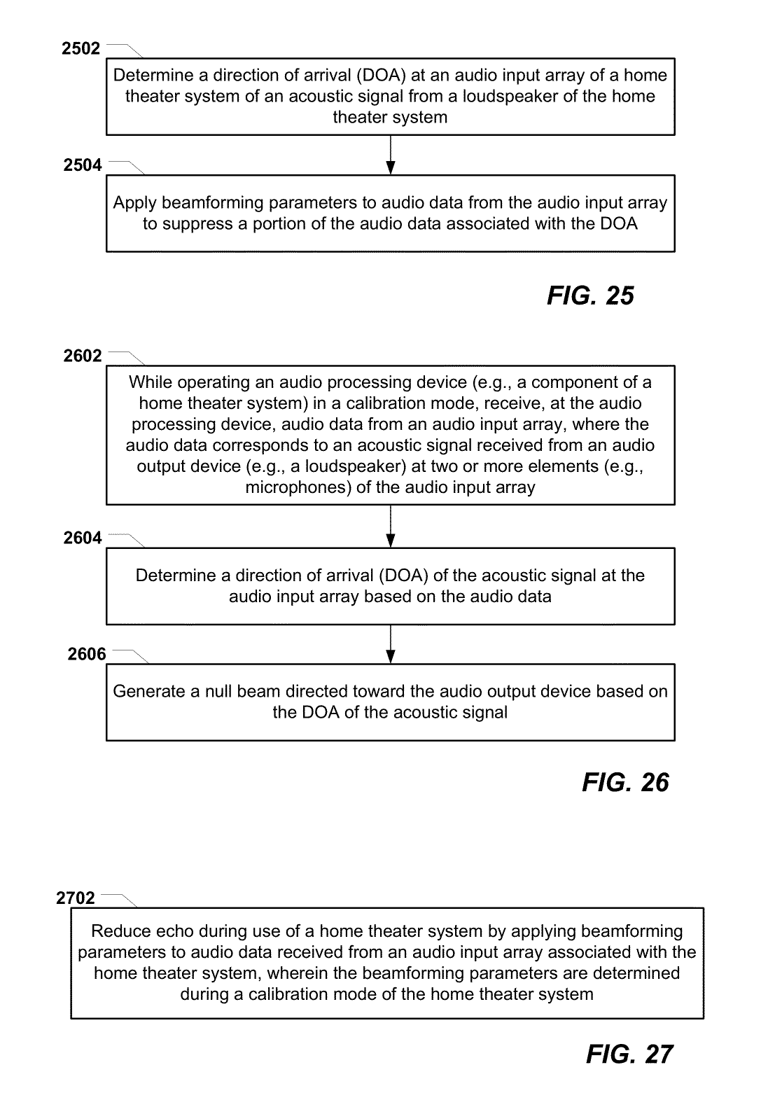

FIG. 25 is a flowchart of a sixth particular embodiment of a method of operation of an audio processing device. As described above, the audio processing device may be a component of a television (such as a “smart” television that includes a processor capable of executing a teleconferencing application) or another home theater component.

The method includes, at 2502, determining a direction of arrival (DOA) at an audio input array of a home theater system of an acoustic signal from a loudspeaker of the home theater system. For example, the audio processing component 140 of the home theater system 100 may determine a DOA to one or more of the loudspeakers 103-109 or the subwoofer 110 by supplying a calibration signal, one-by-one, to each of the loudspeakers 103-109 or the subwoofer 110 and detecting acoustic output at the microphone array 130.

The method may also include, at 2504, applying beamforming parameters to audio data from the audio input array to suppress a portion of the audio data associated with the DOA. For example, the audio processing component 140 may form one or more nulls, such as the nulls 150-156, in the audio data using the determined DOA.

FIG. 26 is a flowchart of a seventh particular embodiment of a method of operation of an audio processing device. As described above, the audio processing device may be a component of a television (such as a “smart” television that includes a processor capable of executing a teleconferencing application) or another home theater component.

The method includes, at 2602, while operating an audio processing device (e.g., a component of a home theater system) in a calibration mode, receiving audio data at the audio processing device from an audio input array. The audio data may correspond to an acoustic signal received from an audio output device (e.g., a loudspeaker) at two or more elements (e.g., microphones) of the audio input array. For example, when the audio receiver 102 of FIG. 1 sends audio data (e.g., the first calibration signal 221) to the loudspeaker 106, the microphone array 130 may detect an acoustic output of the loudspeaker 106 (e.g., acoustic white noise).

The method also includes, at 2604, determining a direction of arrival (DOA) of the acoustic signal at the audio input array based on the audio data. In a particular embodiment, the DOA may be stored in a memory as DOA data, which may be used subsequently in a use mode to suppress audio data associated with the DOA. The method also includes, at 2606, generating a null beam directed toward the audio output device based on the DOA of the acoustic signal.

FIG. 27 is a flowchart of an eighth particular embodiment of a method of operation of an audio processing device. As described above, the audio processing device may be a component of a television (such as a “smart” television that includes a processor capable of executing a teleconferencing application) or another home theater component. The method includes, at 2702, reducing echo during use of a home theater system by applying beamforming parameters to audio data received from an audio input array associated with the home theater system. The beamforming parameters may be determined during operation of the home theater system in a calibration mode. For example, the audio processing component 140 may use beamforming parameters determined based on a DOA of the loudspeaker 106 to generate the null 150 in the audio data. The null 150 may suppress audio data associated with the DOA of the loudspeaker 106, thereby reducing echo associated with acoustic output of the loudspeaker 106 received at the microphone array 130.

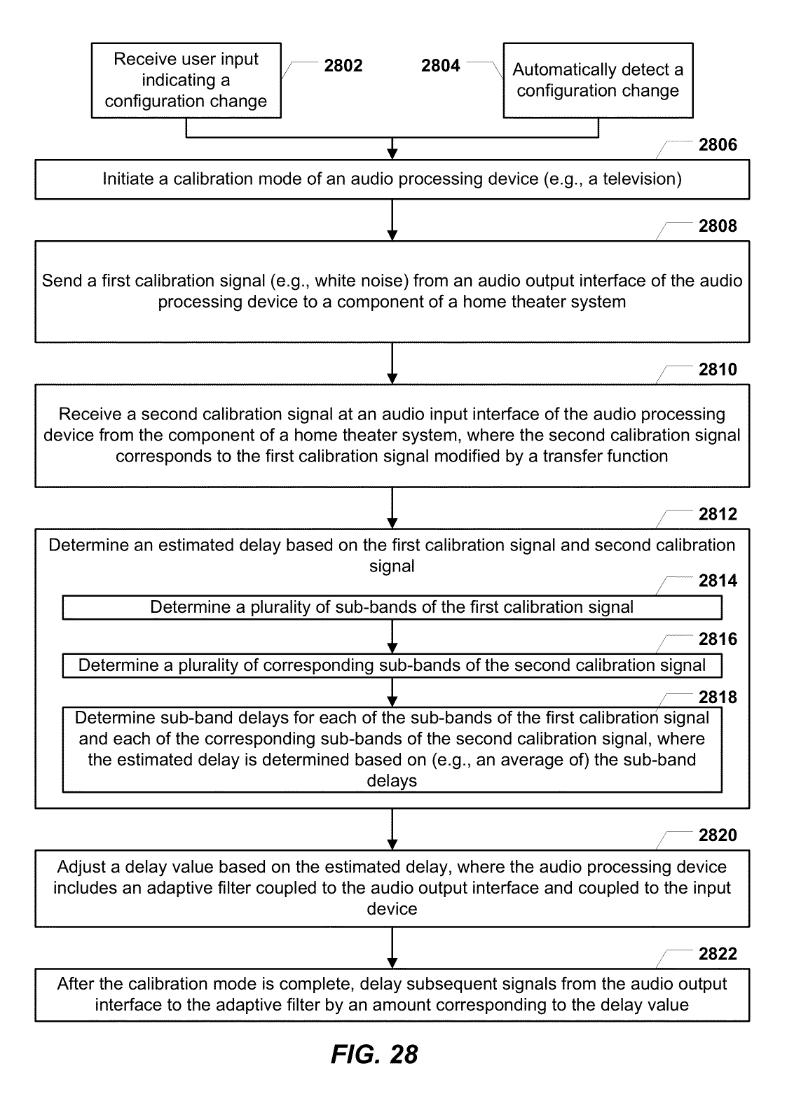

FIG. 28 is a flowchart of a ninth particular embodiment of a method of operation of an audio processing device. As described above, the audio processing device may be a component of a television (such as a “smart” television that includes a processor capable of executing a teleconferencing application) or another home theater component.

The method 2800 includes initiating a calibration mode of the audio processing device, at 2806. For example, the calibration mode may be initiated in response to receiving user input indicating a configuration change, at 2802, or in response to automatically detecting a configuration change, at 2804. The configuration change may be associated with the home theater system, associated with the audio processing device, associated with an acoustic output device, with an input device, or associated with a combination thereof. For example, the configuration change may include coupling a new component to the home theater system or removing a component from the home theater system.

The method 2800 also includes, at 2808, in response to initiation of the calibration mode of the audio processing device, sending a calibration signal (such as white noise) from an audio output interface of the audio processing device to a component of a home theater system.

The method 2800 also includes, at 2810, receiving a second calibration signal at an audio input interface of the audio processing device. The second calibration signal corresponds to the first calibration signal as modified by a transfer function. For example, a difference between the first calibration signal and the second calibration signal may be indicative of electric delay associated with the home theater system or associated with a portion of the home theater system.

The method 2800 also includes, at 2812, determining an estimated delay associated with the home theater system based on the first calibration signal and the second calibration signal. For example, estimating the delay may include, at 2814, determining a plurality of sub-bands of the first calibration signal, and, at 2816, determining a plurality of corresponding sub-bands of the second calibration signal. Sub-band delays for each of the plurality of sub-bands of the first calibration signal and each of the corresponding sub-bands of the second calibration signal may be determined, at 2818. The estimated delay may be determined based on the sub-band delays. For example, the estimated delay may be determined as an average of the sub-band delays.

The method 2800 may further include, at 2820, adjusting a delay value based on the estimated delay. As explained with reference to FIGS. 2 and 3 the audio processing device may include an echo cancellation device 210 that is coupled to the audio output interface 222 and coupled to the input device (such as the microphone 206). At 2822, after the calibration mode is complete, subsequent signals (e.g., audio of a teleconference call) from the audio output interface 222 to the echo cancellation device 210 may be delayed by an amount corresponding to the adjusted delay value.

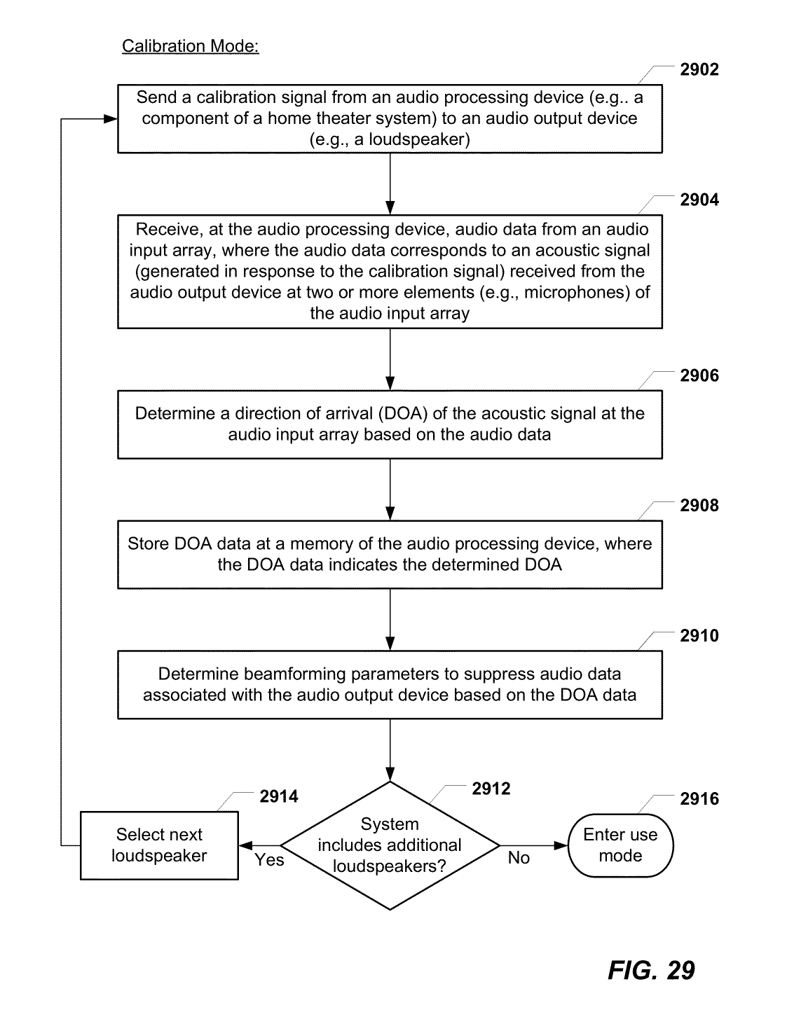

FIG. 29 is a flowchart of a tenth particular embodiment of a method of operation of an audio processing device. As described above, the audio processing device may be a component of a television (such as a “smart” television that includes a processor capable of executing a teleconferencing application) or another home theater component. The method of FIG. 29 may be performed while an audio processing device is operating in a calibration mode.

The method includes sending a calibration signal from an audio processing device to an audio output device, at 2902. An acoustic signal may be generated by the audio output device in response to the calibration signal. For example, the calibration signal may be the first calibration signal 421 of FIG. 4 and the acoustic signal may include acoustic white noise generated by the speaker 404 in response to the first calibration signal 221.

The method may also include receiving, at the audio processing device, audio data from an audio input array, at 2904. The audio data corresponds to an acoustic signal received from an audio output device at two or more elements of the audio input array. For example, the audio processing device may be a component of a home theater system, such as the home theater system 100 of FIG. 1, and the audio output device may be a loudspeaker of the home theater system. In this example, the two or more elements of the audio input array may include microphones associated with the home theater system, such as microphones of the microphone array 130 of FIG. 1.

The method also includes, at 2906, determining a direction of arrival (DOA) of the acoustic signal at the audio input array based on the audio data. For example, the DOA may be determined as described with reference to FIGS. 11A-21C. The method may also include, at 2908, storing DOA data at a memory of the audio processing device, where the DOA data indicates the determined DOA. The method may further include, at 2910, determining beamforming parameters to suppress audio data associated with the audio output device based on the DOA data.

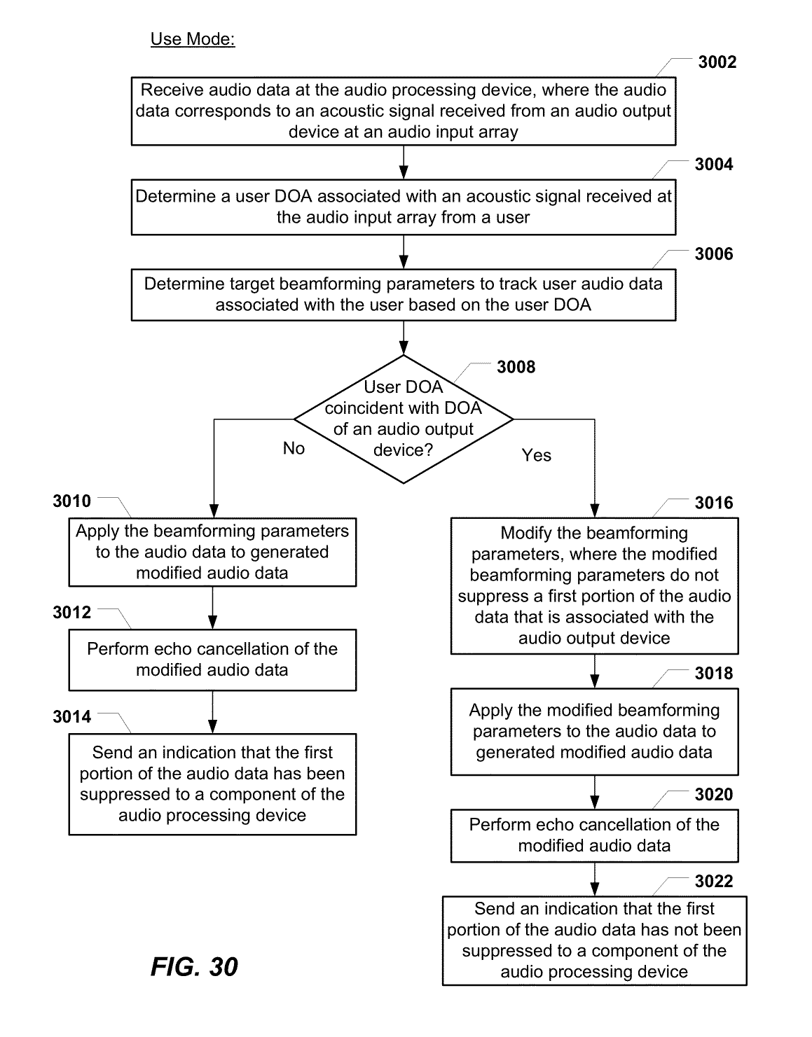

The method may include, at 2912, determining whether the home theater system includes additional loudspeakers. When the home theater system does not include additional loudspeakers, the method ends, at 2916, and the audio processing device is ready to enter a use mode (such as the use mode described with reference to FIG. 30). When the home theater system does include additional loudspeakers, the method may include selecting a next loudspeaker, at 2914, and repeating the method with respect to the selected loudspeaker. For example, the calibration signal may be sent to a first loudspeaker during a first time period, and, after the first time period, a second calibration signal may be sent from the audio processing device to a second audio output device (e.g., the selected loudspeaker). In this example, second audio data may be received at the audio processing device from the audio input array, where the second audio data corresponds to a second acoustic signal received from the second audio output device at the two or more elements of the audio input array. A second DOA of the second acoustic signal at the audio input array may be determined based on the second audio data. Afterwards, the audio processing device may enter the use mode or select yet another loudspeaker and repeat the calibration process for the other loudspeaker.

FIG. 30 is a flowchart of an eleventh particular embodiment of a method of operation of an audio processing device. As described above, the audio processing device may be a component of a television (such as a “smart” television that includes a processor capable of executing a teleconferencing application) or another home theater component. The method of FIG. 30 may be performed while an audio processing device is operating in a use mode (e.g., at least after storing the DOA data, at 2908 of FIG. 29).

The method includes, at 3002, receiving audio data at the audio processing device. The audio data corresponds to an acoustic signal received from an audio output device at an audio input array. For example, the audio data may be received from the microphone array 406 of FIG. 6 and may include audio data based on an acoustic signal generated by the speaker 404 in response to the first signal 621 as well as other audio data, such as user voice input.

The method may include, at 3004, determining a user DOA, where the user DOA is associated with an acoustic signal (e.g., the user voice input) received at the audio input array from a user. The user DOA may also be referred to herein as a target DOA. The method may include, at 3006, determining target beamforming parameters to track user audio data associated with the user based on the user DOA. For example, the target beamforming parameters may be determined as described with reference to FIGS. 19A-21B.

The method may include, at 3008, determining whether the user DOA is coincident with the DOA of the acoustic signal from the audio output device. For example, in FIG. 1, the user DOA of the user 122 is not coincident with the DOA of any of the loudspeakers 103-109; however, if the user 122 moved a bit to his or her left, the user DOA of the user 122 would be coincident with the DOA associated with the loudspeaker 108.

In response to determining that the user DOA is not coincident with the DOA of the acoustic signal from the audio output device, the method may include, at 3010, applying the beamforming parameters to the audio data to generated modified audio data. In a particular embodiment, the audio data may correspond to acoustic signals received at the audio input array from the audio output device and from one or more additional audio output devices, such as the loudspeakers 103-109 of FIG. 1. In this embodiment, applying the beamforming parameters to the audio data may suppress a first portion of the audio data that is associated with the audio output device and may not eliminate a second portion of the audio data that is associated with the one or more additional audio output devices. To illustrate, referring to FIG. 1, the microphone array 130 may detect acoustic signals from each of the loudspeakers 103-109 to form the audio data. The audio data may be modified by applying beamforming parameters to generate the nulls 150-156 to suppress (e.g., eliminate) a portion of the audio data that is associated with the DOAs of the front loudspeakers 106-109; however, the portion of the audio data that is associated with the rear facing loudspeakers 103-105 and the subwoofer may not be suppressed, or may be partially suppressed, but not eliminated.

The method may also include, at 3012, performing echo cancellation of the modified audio data. For example, the echo processing components 613 of FIG. 6 may perform echo cancellation on the modified audio data. The method may include, at 3014, sending an indication that the first portion of the audio data has been suppressed to a component of the audio processing device. For example, the indication may include the pass indicator of FIG. 8. In a particular embodiment, echo cancellation may be performed on the audio data before the beamforming parameters are applied rather than after the beamforming parameters are applied. In this embodiment, the indication that the first portion of the audio data has been suppressed may not be sent.

In response to determining that the user DOA is coincident with the DOA of the acoustic signal from the audio output device, the method may include, at 3016, modifying the beamforming parameters before applying the beamforming parameters to the audio data. The beamforming parameters may be modified such that the modified beamforming parameters do not suppress a first portion of the audio data that is associated with the audio output device. For example, referring to FIG. 1, when the user DOA of the user 122 is coincident with the DOA of the loudspeaker 108, the beamforming parameters may be modified such that audio data associated with the DOA of the loudspeaker 108 is not suppressed (e.g., to avoid also suppressing audio data from the user 122). The modified beamforming parameters may be applied to the audio data to generate modified audio data, at 3018. Audio data associated with one or more DOAs, but not the DOA that is coincident with the user DOA, may be suppressed in the modified audio data. To illustrate, continuing the previous example, the audio data may be modified to suppress a portion of the audio data that is associated with the loudspeakers 106, 107 and 109, but not the loudspeaker 108, since the DOA of the loudspeaker 108 is coincident with the user DOA in this example.

The method may include, at 3020, performing echo cancellation of the modified audio data. The method may also include, at 3022, sending an indication that the first portion of the audio data has not been suppressed to a component of the audio processing device. The indication that the first portion of the audio data has not been suppressed may include the fail indicator of FIG. 8.

Accordingly, embodiments disclosed herein enable echo cancellation in circumstances where multiple audio output devices, such as loudspeakers, are sources of echo. Further, the embodiments reduce computation power used for echo cancellation by using beamforming to suppress audio data associated with one or more of the audio output devices.

Those of skill would appreciate that the various illustrative logical blocks, configurations, modules, circuits, and algorithm steps described in connection with the embodiments disclosed herein may be implemented as electronic hardware, computer software, or combinations of both. Various illustrative components, blocks, configurations, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The steps of a method or algorithm described in connection with the embodiments disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of non-transitory storage medium. An exemplary storage medium is coupled to the processor such that the processor can read information from, and write information to, the storage medium. In the alternative, the storage medium may be integral to the processor. The processor and the storage medium may reside in an application-specific integrated circuit (ASIC). The ASIC may reside in a computing device or a user terminal (e.g., a mobile phone or a PDA). In the alternative, the processor and the storage medium may reside as discrete components in a computing device or user terminal.

The previous description of the disclosed embodiments is provided to enable a person skilled in the art to make or use the disclosed embodiments. Various modifications to these embodiments will be readily apparent to those skilled in the art, and the principles defined herein may be applied to other embodiments without departing from the scope of the disclosure. Thus, the present disclosure is not intended to be limited to the embodiments disclosed herein but is to be accorded the widest scope possible consistent with the principles and novel features as defined by the following claims.

What is claimed is:

1. A method comprising:
while operating an audio processing device in a use mode, retrieving first direction of arrival (DOA) data corresponding to a first audio output device from a memory of the audio processing device;
generating a first null beam directed toward the first audio output device based on the first DOA data;
retrieving second DOA data corresponding to a second audio output device from the memory of the audio processing device; and
generating a second null beam directed toward the second audio output device based on the second DOA data;
wherein the first DOA data and the second DOA data were stored in the memory during operation of the audio processing device in a calibration mode.

2. The method of claim 1, wherein the audio processing device is a component of a home theater system and the first audio output device and the second audio output device are a loudspeakers of the home theater system.

3. The method of claim 1, wherein further comprising applying an estimated electric delay to received audio data before generating the first null beam in the received audio data.

4. The method of claim 1, wherein further comprising applying an estimated electric delay to received audio data after generating the first null beam in the received audio data.

5. The method of claim 1, wherein operation in the calibration mode includes:
sending a first calibration signal from the audio processing device to the first audio output device;
receiving a first acoustic signal at an audio input array of the audio processing device from the first audio output device, wherein the first acoustic signal is generated by the first audio output device in response to the first calibration signal;
determining the first DOA data based on the first acoustic signal; and
storing the first DOA data at the memory.

6. The method of claim 5, wherein operation in the calibration mode further includes:
sending a second calibration signal from the audio processing device to the second audio output device;
receiving a second acoustic signal at the audio input array of the audio processing device from the second audio output device, wherein the second acoustic signal is generated by the second audio output device in response to the second calibration signal;
determining the second DOA data based on the second acoustic signal; and
storing the second DOA data at the memory.

7. The method of claim 6, wherein the first calibration signal is sent during a first time period and the second calibration signal is sent during a second time period that is after the first time period.

8. The method of claim 1, wherein generating the first null beam includes determining first beamforming parameters to suppress first audio data associated with the first audio output device based on the first DOA data, and generating the second null beam includes determining second beamforming parameters to suppress second audio data associated with the second audio output device based on the second DOA data.

9. The method of claim 8, further comprising:
while operating in the use mode, receiving audio data at the audio processing device, wherein the audio data corresponds to a plurality of acoustic signals received at an audio input array from a plurality of audio output devices; and
applying the first and second beamforming parameters to the audio data to generate modified audio data.

10. The method of claim 9, further comprising performing echo cancellation of the modified audio data.

11. The method of claim 9, further comprising performing echo cancellation of the audio data before applying the beam forming parameters.

12. The method of claim 9, wherein the plurality of audio output devices include the first audio output device, the second audio output device and one or more additional audio output devices, and wherein applying the beamforming parameters to the audio data suppresses a first portion of the audio data that is associated with the first audio output device, suppresses a second portion of the audio data that is associated with the second audio output device, and does not eliminate a third portion of the audio data that is associated with the one or more additional audio output devices.

13. The method of claim 9, further comprising, while operating in the use mode:
determining a user DOA, wherein the user DOA is associated with an acoustic signal received at the audio input array from a user; and
determining target beamforming parameters to track user audio data associated with the user based on the user DOA.

14. The method of claim 13, further comprising, before generating the first null beam:
determining whether the user DOA is coincident with a DOA of a first acoustic signal from the first audio output device; and
in response to determining that the user DOA is coincident with the DOA of the first acoustic signal from the first audio output device, modifying the beamforming parameters before applying the beamforming parameters to the audio data, wherein the modified beamforming parameters do not suppress a first portion of the audio data that is associated with the first audio output device.

15. The method of claim 14, further comprising sending an indication that the first portion of the audio data has not been suppressed to a component of the audio processing device.

16. An apparatus comprising:
an audio processing device including:
a memory to store direction of arrival (DOA) data that is determined while the audio processing device is operating in a calibration mode; and
a beamforming device, wherein, while the audio processing device is operating in a use mode, the beamforming device performs operations including:
retrieving first DOA data corresponding to a first audio output device from the memory;
generating a first null beam directed toward the first audio output device based on the first DOA data;
retrieving second DOA data corresponding to a second audio output device from the memory; and
generating a second null beam directed toward the second audio output device based on the second DOA data.

17. The apparatus of claim 16, wherein the audio processing device is a component of a home theater system and the first and second audio output devices are loudspeakers of the home theater system.

18. The apparatus of claim 17, further comprising an audio input array including multiple microphones associated with the home theater system.

19. The apparatus of claim 16, wherein the audio processing device is configured to send a first calibration signal to the first audio output device while the audio processing device is operating in the calibration mode, wherein a first acoustic signal is generated by the first audio output device in response to the first calibration signal, and wherein the first DOA data is determined based on the first acoustic signal.

20. The apparatus of claim 19, wherein the first calibration signal is sent to the first audio output device during a first time period, and wherein the audio processing device is further configured to, after the first time period and while operating in the calibration mode, send a second calibration signal to the second audio output device, wherein a second acoustic signal is generated by the second audio output device in response to the second calibration signal, and wherein the second DOA data is determined based on the second acoustic signal.

21. The apparatus of claim 16, wherein the audio processing device generates the first null beam by determining beamforming parameters to suppress audio data associated with the first audio output device based on the first DOA data.

22. The apparatus of claim 21, wherein the beamforming device generates the first null beam while operating in the use mode by:
receiving third audio data, wherein the third audio data corresponds to an acoustic signal received from the first audio output device at an audio input array of the audio processing device; and
applying the beamforming parameters to the third audio data to generated modified third audio data.

23. The apparatus of claim 22, wherein the audio processing device is configured to perform echo cancellation of the modified third audio data.

24. The apparatus of claim 22, wherein the audio processing device is configured to perform echo cancellation of the third audio data before applying the beam forming parameters.

25. The apparatus of claim 22, wherein the third audio data corresponds to acoustic signals received at the audio input array from the first audio output device and from one or more additional audio output devices, and wherein applying the beamforming parameters to the third audio data suppresses a first portion of the third audio data that is associated with the first audio output device and does not eliminate a second portion of the third audio data that is associated with the one or more additional audio output devices.

26. The apparatus of claim 22, wherein the audio processing device is configured to, while operating in the use mode:
determine a user DOA, wherein the user DOA is associated with an acoustic signal received from a user at the audio input array of the audio processing device; and
determine target beamforming parameters to track user audio data associated with the user based on the user DOA.

27. The apparatus of claim 26, wherein the audio processing device is configured to:
determine whether the user DOA is coincident with the DOA of the acoustic signal from the first audio output device; and
in response to determining that the user DOA is coincident with the DOA of the acoustic signal from the first audio output device, modify the beamforming parameters before applying the beamforming parameters to the third audio data, wherein the modified beamforming parameters do not suppress a first portion of the third audio data that is associated with the first audio output device.

28. The apparatus of claim 27, wherein the audio processing device is configured to send an indication that the first portion of the third audio data has not been suppressed to a component of the audio processing device.

29. The apparatus of claim 27, wherein the audio processing device is configured to send an indication that the first portion of the third audio data has been suppressed to a component of the audio processing device.

30. A non-transitory computer-readable medium storing instructions that are executable by a processor to cause the processor to perform operations comprising:
while operating an audio processing device in a use mode, retrieving first direction of arrival (DOA) data corresponding to a first audio output device from a memory;
generating a first null beam directed toward the first audio output device based on the first DOA data;
retrieving second DOA data corresponding to a second audio output device from the memory of the audio processing device; and
generating a second null beam directed toward the second audio output device based on the second DOA data;
wherein the first DOA data and the second DOA data were stored in the memory during operation of the audio processing device in a calibration mode.

31. The non-transitory computer-readable medium of claim 30, wherein the operations further include:
while operating in the calibration mode, causing a first calibration signal to be sent to the first audio output device from the audio processing device, wherein a first acoustic signal is generated by the first audio output device in response to the first calibration signal;
receiving first audio data from an audio input array of the audio processing device, wherein the first audio data corresponds to the first acoustic signal received from the first audio output device at two or more elements of the audio input array; and
determining the first DOA based on the first audio data.

32. The non-transitory computer-readable medium of claim 31, wherein the first calibration signal is sent to the first audio output device during a first time period, and wherein the operations further include, after the first time period:
causing a second calibration signal to be sent to the second audio output device, wherein the first audio output device is a first loudspeaker of a home theater system and the second audio output device is a second loudspeaker of the home theater system;
receiving second audio data from the audio input array, wherein the second audio data corresponds to a second acoustic signal received from the second audio output device at the two or more elements of the audio input array; and
determining the second DOA based on the second audio data.

33. The non-transitory computer-readable medium of claim 30, wherein generating the first null beam includes determining beamforming parameters to suppress audio data associated with the first audio output device based on the first DOA data.

34. The non-transitory computer-readable medium of claim 33, wherein generating the null beam includes, after storing the DOA data:
while operating in the use mode, receiving third audio data, wherein the third audio data corresponds to a third acoustic signal received from the first audio output device at an audio input array; and
applying the beamforming parameters to the third audio data to generated modified third audio data.

35. The non-transitory computer-readable medium of claim 34, wherein the operations further include performing echo cancellation of the modified third audio data.

36. The non-transitory computer-readable medium of claim 34, wherein the operations further include performing echo cancellation of the third audio data before applying the beam forming parameters.

37. The non-transitory computer-readable medium of claim 34, wherein the third audio data corresponds to acoustic signals received at the audio input array from the first audio output device and from one or more additional audio output devices, and wherein applying the beamforming parameters to the third audio data suppresses a first portion of the third audio data that is associated with the first audio output device and does not eliminate a second portion of the third audio data that is associated with the one or more additional audio output devices.

38. The non-transitory computer-readable medium of claim 34, wherein the operations further include, while operating in the use mode:
determining a user DOA, wherein the user DOA is associated with an acoustic signal received at the audio input array from a user; and
determining target beamforming parameters to track user audio data associated with the user based on the user DOA.

39. The non-transitory computer-readable medium of claim 38, wherein the operations further include:
determining whether the user DOA is coincident with the first DOA; and
in response to determining that the user DOA is coincident with the first DOA, modifying the beamforming parameters before applying the beamforming parameters to the third audio data, wherein the modified beamforming parameters do not suppress a first portion of the third audio data that is associated with the first audio output device.

40. The non-transitory computer-readable medium of claim 39, wherein the operations further include causing an indication that the first portion of the third audio data has not been suppressed to be sent to a component of the audio processing device.

41. The non-transitory computer-readable medium of claim 39, wherein the operations further include causing an indication that the first portion of the third audio data has been suppressed to be sent to a component of the audio processing device.

42. An apparatus comprising:
means for storing direction of arrival (DOA) data determined while an audio processing device operated in a calibration mode; and
means for generating a null beam based on the DOA data stored at the means for storing DOA data, wherein the means for generating a null beam is configured to, while the audio processing device is operating in a use mode:
retrieve first DOA data corresponding to a first audio output device from the means for storing DOA data and generate a first null beam directed toward the first audio output device based on the first DOA data; and
retrieve second DOA data corresponding to a second audio output device from the means for storing DOA data and generate a second null beam directed toward the second audio output device based on the second DOA data.

43. The apparatus of claim 42, wherein the audio processing device is a component of a home theater system and the first and second audio output devices are a loudspeakers of the home theater system.

44. The apparatus of claim 43, further comprising means for receiving acoustic data associated with the home theater system.

45. The apparatus of claim 42, further comprising means for calibrating the audio processing device, wherein the means for calibrating the audio processing device is operable in the calibration mode to send a first calibration signal to the first audio output device, wherein a first acoustic signal is generated by the first audio output device in response to the first calibration signal, and wherein the first DOA data is determined based on the first acoustic signal.

46. The apparatus of claim 45, wherein the means for calibrating the audio processing device sends the first calibration signal to the first audio output device during a first time period, and wherein the means for calibrating the audio processing device is further operable, while operating in the calibration mode and after the first time period, to send a second calibration signal to the second audio output device, wherein a second acoustic signal is generated by the second audio output device in response to the second calibration signal, and wherein the second DOA data is determined based on the first acoustic signal.

47. The apparatus of claim 42, wherein the means for generating a null beam generates the first null beam by determining beamforming parameters to suppress audio data associated with the first audio output device based on the first DOA data.

48. The apparatus of claim 42, further comprising echo cancelation means configured to perform echo cancellation with respect to received audio data.

49. The apparatus of claim 48, wherein the received audio data corresponds to acoustic signals received at an audio input array from the first audio output device and from one or more additional audio output devices.

50. The apparatus of claim 42, further comprising:
means for determining a user DOA while operating in the use mode, wherein the user DOA is associated with an acoustic signal received at an audio input array of the audio processing device from a user; and
means for determining target beamforming parameters to track user audio data associated with the user based on the user DOA.

51. The apparatus of claim 50, wherein the means for generating a null beam is further configured to:
determine whether the user DOA is coincident with a DOA of a third audio output device; and
in response to determining that the user DOA is coincident with the DOA of the third audio output device, modify beamforming parameters before generating the first null beam and the second null beam, wherein the beamforming parameters are modified such that no null beam is associated with the third audio output device.

52. The apparatus of claim 51, wherein the means for generating a null beam is further configured to, after determining that the user DOA is coincident with the DOA of the third audio output device, send an indication that audio data associated with the third audio output device has not been suppressed to a component of the audio processing device.

53. A method of using an audio processing device during a conference call, the method comprising:
delaying, by a delay amount, application of a signal to an echo cancelation device of an audio processing device, wherein the delay amount is determined based on an estimated electric delay between an audio output interface of the audio processing device and a second device of a home theater system, wherein the estimated electric delay is obtained during operation of the audio processing device in a calibration mode.

54. The method of claim 53, wherein the delay amount is independent of changes in acoustical delay of a microphone array coupled to the audio processing device.

55. The method of claim 54, wherein the changes in the acoustic delay correspond to changes in orientation of the microphone array, changes in orientation of a speaker of the home theater system, or both.

56. The method of claim 55, wherein an amount of change in the acoustical delay resulting from changes in the orientation of the microphone array, changes in the orientation of the speaker of the home theater system, or both, is less than 30 milliseconds.

57. The method of claim 53, wherein the second device includes one of an audio receiver, a set top box, a television, or a combination thereof.

58. The method of claim 53, wherein the audio processing device is a component within a television and the home theater system includes an audio output device, the audio output device including one or more speakers that are remote from the television.

59. The method of claim 53, further comprising initiating operation of the audio processing device in the calibration mode in response to detecting a configuration change associated with the home theater system.

60. The method of claim 59, wherein the configuration change is detected automatically by the audio processing device.

61. The method of claim 53, further comprising initiating operation of the audio processing device in the calibration mode in response to detecting a configuration change associated with the audio processing device, in response to detecting a configuration change associated with a speaker, or a combination thereof.

62. The method of claim 53, further comprising, during operation of the audio processing device in the calibration mode:
sending a calibration signal from the audio output interface of the audio processing device to the second device; and
receiving, at the audio processing device from the second device, a second signal based on the calibration signal; and
determining the estimated electric delay based on the second signal.

63. The method of claim 62, wherein the second signal is an electric signal.

64. The method of claim 62, wherein the second signal is an acoustic signal with embedded timing information.

65. The method of claim 62, further comprising:
determining a plurality of sub-bands of the calibration signal;
determining a plurality of corresponding sub-bands of the second signal; and
determining sub-band delays for each of the plurality of sub-bands of the calibration signal and each of the corresponding sub-bands of the second signal, wherein the estimated electric delay is determined based on the sub-band delays.

66. The method of claim 65, wherein the estimated electric delay is determined as an average of the sub-band delays.

67. An apparatus comprising:
means for reducing echo in a second signal based on a first signal; and
means for delaying, by a delay amount, application of the first signal to the means for reducing echo, wherein the delay amount is determined based on an estimated electric delay between an audio output interface of an audio processing device and a second device of a home theater system, wherein the estimated electric delay is obtained during operation of the audio processing device in a calibration mode.

68. The apparatus of claim 67, further comprising means for receiving the second signal from a microphone array, wherein the delay amount is independent of changes in acoustical delay associated with the microphone array.

69. The apparatus of claim 68, wherein the changes in the acoustic delay correspond to changes in orientation of the microphone array, changes in orientation of a speaker of the home theater system, or both.

70. The apparatus of claim 69, wherein an amount of change in the acoustical delay resulting from changes in the orientation of the microphone array, changes in the orientation of the speaker of the home theater system, or both, is less than 30 milliseconds.

71. The apparatus of claim 67, wherein the second device includes one of an audio receiver, a set top box, a television, or a combination thereof.

72. The apparatus of claim 67, integrated within a television, wherein the home theater system includes an audio output device, the audio output device including one or more speakers that configured to be positioned remote from the television.

73. The apparatus of claim 67, further comprising means for initiating operation of the audio processing device in the calibration mode in response to detecting a configuration change associated with the home theater system.

74. The apparatus of claim 73, further comprising means for detecting the configuration change.

75. The apparatus of claim 67, further comprising:
means for sending a first calibration signal, during operation of the audio processing device in the calibration mode, from the audio output interface of the audio processing device to the second device;
means for receiving a second calibration signal, during operation of the audio processing device in the calibration mode, wherein the second calibration signal is based on the first calibration signal; and
means for determining the estimated electric delay based on the second calibration signal.

76. The apparatus of claim 75, wherein the second calibration signal is an electric signal.

77. The apparatus of claim 75, wherein the second calibration signal is an acoustic signal with embedded timing information.

78. The apparatus of claim 75, further comprising:
means for determining a plurality of sub-bands of the first calibration signal;
means for determining a plurality of corresponding sub-bands of the second calibration signal; and
means for determining sub-band delays for each of the plurality of sub-bands of the first calibration signal and each of the corresponding sub-bands of the second calibration signal, wherein the estimated electric delay is determined based on the sub-band delays.

79. The apparatus of claim 78, wherein the estimated electric delay is determined as an average of the sub-band delays.

80. An apparatus comprising:
an audio processing device including:
an audio input interface to receive a first signal an audio output interface to send the first signal to a second device of a home theater system;
an echo cancellation device coupled to the audio output interface and the audio input interface, the echo cancellation device configured to reduce echo associated with an acoustic signal generated by an acoustic output device of the home theater system and received at an input device coupled to the audio processing device; and
a delay component coupled between the audio output interface and the echo cancellation device, the delay component configured to delay, by a delay amount, application of the first signal to the echo cancelation device, wherein the delay amount is determined based on an estimated electric delay between the audio output interface of the audio processing device and the second device of the home theater system, wherein the estimated electric delay is obtained during operation of the audio processing device in a calibration mode.

81. The apparatus of claim 80, further comprising a second audio input configured to couple to a microphone array, wherein the acoustic signal generated by the acoustic output device is received from the microphone array, and wherein the delay amount is independent of changes in acoustical delay associated with the microphone array.

82. The apparatus of claim 81, wherein the changes in the acoustic delay correspond to changes in orientation of the microphone array, changes in orientation of a speaker of the home theater system, or both.

83. The apparatus of claim 82, wherein an amount of change in the acoustical delay resulting from changes in the orientation of the microphone array, changes in the orientation of the speaker of the home theater system, or both, is less than 30 milliseconds.

84. The apparatus of claim 80, wherein the second device includes one of an audio receiver, a set top box, a television, or a combination thereof.

85. The apparatus of claim 80, wherein the audio processing device is integrated within a television, wherein the home theater system includes an audio output device, the audio output device including one or more speakers that configured to be positioned remote from the television.

86. The apparatus of claim 80, wherein the audio processing device is configured to automatically initiate operation of the audio processing device in the calibration mode in response to detecting a configuration change associated with the home theater system.

87. The apparatus of claim 86, wherein the audio processing device is further configured to detect the configuration change.

88. The apparatus of claim 80, further comprising:
a calibration signal generator to send a first calibration signal, during operation of the audio processing device in the calibration mode, from the audio output interface of the audio processing device to the second device;
a receiver to receive a second calibration signal, during operation of the audio processing device in the calibration mode, wherein the second calibration signal is based on the first calibration signal; and
a delay processing component to estimated electric delay based on the second calibration signal.

89. The apparatus of claim 88, wherein the second calibration signal is an electric signal.

90. The apparatus of claim 88, wherein the second calibration signal is an second acoustic signal that includes embedded timing information.

91. The apparatus of claim 88, wherein the delay processing component is further configured to:
determine a plurality of sub-bands of the first calibration signal;
determine a plurality of corresponding sub-bands of the second calibration signal; and
determine sub-band delays for each of the plurality of sub-bands of the first calibration signal and each of the corresponding sub-bands of the second calibration signal; and
determine the estimated electric delay based on the sub-band delays.

92. The apparatus of claim 91, wherein the estimated electric delay is determined as an average of the sub-band delays.
